(19) United States
(12) Patent Application Publication
(10) Pub. No.: US 2007/0015563 A1
(43) Pub. Date: Jan. 18, 2007

(54) Gaming machine

(75) Inventors: Kazuyuki Yanagi, Tokyo (JP); Katsumi Yamaguchi, Tokyo (JP); Shinji Suzuki, Tokyo (JP); Yoshihiro Ando, Tokyo (JP); Hirotomo Suzuki, Sagamihara-shi (JP); Keigo Matsumoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/392,929

(22) Filed: Mar. 30, 2006

(30) Foreign Application Priority Data
Jun. 9, 2005 (JP) 2005-169106

(51) Int. Cl. A63F 9/24; A63F 13/00

(52) U.S. Cl. 463/16; 463/21; 463/26

(57) ABSTRACT

In a gaming machine according to the present invention, a main control circuit transmits, to a sub control circuit, a variable display pattern command which is indicative of the variable display pattern of identification information and identifies whether or not variable display of identification information should result in a specific display mode and a variable display result command indicative of the result of variable display of identification information. If the sub control circuit determines that the combination of the received variable display pattern command and the received variable display result command is a combination at the time of an error, it detects a predetermined error and notifies the result of the detection.

### CROSS-REFERENCE TO RELATED APPLICATION

This application claims the benefit of priority based on Japanese Patent Application No. 2005-169106, filed on Jun. 9, 2005.

The contents of that application are incorporated by reference herein in their entirety.

### BACKGROUND OF THE INVENTION

1. Field of the Invention

The present invention relates to a gaming machine and, more particularly, relates to a gaming machine capable of variably displaying identification information.

2. Discussion of the Background

Conventionally, there have been gaming machines such as pachinko gaming machines comprising variable display control means for conducting controls for variably displaying identification information on the display region of a variable display device and, also, conducting controls for derivatively displaying identification information after the variable display thereof, in the event that a predetermined variable display starting condition is established, such as in the event that a launched gaming ball passes a starting region provided on a game region which allows gaming balls to roll thereon, wherein in the event that identification information is derivatively displayed in a specific display mode, the gaming state is shifted to a big-hit gaming state (so-called “big-hit”) which is advantageous to players. Further, in the event of a non-hit, variable display of identification information results in a non-specific display mode.

On the other hand, such gaming machines generally comprise a main control circuit that controls games and a sub control circuit that controls effects in accordance with the progress of games, wherein the main control circuit determines commands indicative of controls of games and supplies the commands to the sub control circuit so that the sub control circuit can control effects in accordance with the progress of games.

More specifically, the main control circuit determines whether or not the gaming state should be shifted to a big-hit gaming state and also determines the result of variable display of identification information on the basis of the result of the aforementioned determination. Further, on the basis of the determined result of variable display of identification information, the main control circuit determines the variable display pattern of identification information. Then, the main control circuit transmits, to the sub control circuit, a derivative symbol designation command indicative of the result of variable display of identification information, a variable pattern designation command which is indicative of the variable display pattern of identification information and also identifies whether or not variable display of identification information should result in a specific display mode, and the like. On receiving these commands, the sub control circuit conducts controls for causing identification information variably displaying effects in accordance with the type of the variable pattern designation command and for causing the result of variable display of identification information to be derivatively displayed, in accordance with the derivative symbol designation command.

In a gaming machine of this type, for example, as described in JP-A 2004-222875, if it is determined that a variable pattern designation command and a derivative symbol designation command have been received from the main control circuit, the result of variable display of identification information is determined on the basis of the variable pattern designation command. Further, reference is made to the variable pattern designation command and the derivative symbol designation command and, if the variable pattern designation command is a command for causing variable display of identification information to result in a specific display mode and the derivative display designation command is a command for causing variable display of identification information not to result in a specific display mode or vice versa, initially set non-hit symbols are determined as derivative symbols of identification information. On the other hand, if the gaming state is shifted to a big-hit gaming state, predetermined big-hit symbols are determined as derivative symbols of identification information.

However, the aforementioned gaming machine causes identification information which is different from to-be-derivatively-displayed identification information to be derivatively displayed, which degrades the reliability of the derivatively displayed identification information, thereby causing the player to be suspicious of games and reducing enjoyment.

The contents of JP-A 2004-222875 are incorporated by reference herein in their entirety.

### SUMMARY OF THE INVENTION

The present invention has been made in view of the aforementioned problem and aims at providing a gaming machine capable of enhancing the reliability of derivatively displayed identification information, thereby preventing the reduction of enjoyment.

In order to attain the aforementioned object, the present invention provides the following gaming machines.

(1) A gaming machine comprising: variable display means for conducting variable display of identification information; game control means for controlling games; and effect control means for controlling effects in accordance with the progress of games, the game control means including: big-hit gaming state shifting control means for conducting controls for shifting the gaming state to a big-hit gaming state advantageous to a player, on the condition that variable display of the identification information has resulted in a specific display mode; big-hit determination means for determining whether or not the gaming state should be shifted to the big-hit gaming state; variable display result determination means for determining the result of variable display of the identification information, on the basis of the result of determination by the big-hit determination means; variable display pattern determination means for determining the variable display pattern of the identification information, on the basis of the result of variable display of the identification information determined by the variable display result determination means; and command transmission means for transmitting a variable display result command indicative of the result of variable display of the identification information determined by the variable display result determination means and a variable display pattern command indicative of the variable display pattern of the identification information determined by the variable display pattern determination means, and the effect control means including: command reception means for receiving commands transmitted from the command transmission means; and variable display control means for causing identification information variably displaying effects in accordance with the type of the variable display pattern command received by the command reception means and for causing the result of variable display of identification information to be derivatively displayed, in accordance with the variable display result command received by the command reception means, wherein the command transmission means has the function of transmitting the variable display pattern command, in such a manner that it identifies whether or not variable display of the identification information should result in a specific display mode, the effect control means including: command combination data storage means for storing data capable of identifying the combination of the variable display pattern command and the variable display result command at the time of an error; command determination means for determining the combination of the variable display pattern command and the variable display result command each received by the command reception means; error determination means for determining a predetermined error in the case where the command determination means determines that the combination of the variable display pattern command and the variable display result command is a combination at the time of an error, on the basis of the data stored in the command combination data storage means; and determination result notification means for notifying the result of the detection in the case where the error determination means determines a predetermined error.

(2) In the gaming machine described in (1), the game control means includes special gaming state shifting control means for conducting controls for shifting the gaming state to a special gaming state where variable display of the identification information can readily result in the specific display mode with higher probability, after the completion of the big-hit gaming state, on the condition that variable display of the identification information has resulted in a special display mode out of the specific display modes, and the command transmission means has the function of transmitting the variable display pattern command, in such a manner that it identifies whether or not variable display of the identification information should result in a special display mode.

(3) In the gaming machine described in (1) or (2), the effect control means includes: type-of-display-result determination means for selecting any one of plural types of results of variable display of identification information which are not specific display modes, in the case where the command reception means receives a variable display pattern command for causing variable display of the identification information not to result in a specific display mode, and the variable display control means has the function of causing the result of variable display of identification information determined by the type-of-display-result determination means, which is not a specific display mode, to be derivatively displayed, in the case where the command determination means determines that the combination of commands received by the command reception means is a combination of a variable display pattern command for causing variable display of identification information not to result in a specific display mode and a variable display result command for causing variable display of identification information to result in a specific display mode.

According to the invention described in (1), there is stored data capable of identifying the combination of a variable display pattern command and a variable display result command is an error. Further, the combination of the received variable display pattern command and the variable display result command is determined whether or not it is a combination at the time of an error. As a result, on the basis of the stored data, if the combination of the received variable display pattern command and the variable display result command is determined to be a combination at the time of an error, it is determined that the error is a predetermined error, then the result of the determination is indicated. Accordingly, for example, if a transmitted variable display pattern command and a transmitted variable display result command are accidentally changed due to noises or the like, thus resulting in an abnormal combination of the identification information variably displaying pattern and the result of variable display of identification information, this will be indicated as a predetermined error, which can enhance the reliability of the derivatively displayed identification information without inducing confusion about games, thereby preventing the reduction of enjoyment.

According to the invention described in (2), on the condition that variable display of identification information has resulted in a special display mode out of specific display modes, the gaming state is shifted to a special gaming state where variable display of identification information can readily result in a specific display mode, after the end of the big-hit gaming state, and also a variable display pattern command as described above is transmitted, wherein the variable display pattern command identifies whether or not the variable display of identification information should result in a special display mode. Accordingly, for example, even if the received commands are a variable display pattern command for causing variable display of identification information to result in a special display mode and a variable display result command for causing variable display of identification information to result in a non-special display mode, thus indicating an abnormal combination of the identification information variably displaying pattern and the result of variable display of identification information as a predetermined error, this can enhance the reliability of the derivatively displayed identification information without inducing confusion about games, thereby preventing the reduction of enjoyment.

According to the invention described in (3), if the combination of received commands is determined to be a variable display pattern command for causing variable display of identification information not to result in a specific display mode and a variable display result command for causing variable display of identification information to result in a specific display mode, then a result of variable display of identification information which is not in a specific display mode is derivatively displayed. Accordingly, if the combination of received commands is a variable display pattern command for causing variable display of identification information not to result in a specific display mode and a variable display result command for causing variable display of identification information to result in a specific display mode, this will not be notified as an error. Even when a result of variable display of identification information which is not in a specific display mode is derivatively displayed, there is a lower possibility that the player can notice the occurrence of an error, which can smoothly progress games and prevent the reduction of the reliability of the derivatively displayed identification information, thereby preventing the reduction of enjoyment.

According to the present invention, it is possible to enhance the reliability of derivatively displayed identification information, thereby preventing the reduction of enjoyment.

### BRIEF DESCRIPTION OF THE DRAWINGS

FIG. 1 is an external view illustrating the overview of a pachinko gaming machine according to an embodiment of the present invention;

FIG. 2 is an exploded perspective view illustrating the overview of the pachinko gaming machine according to the embodiment of the present invention;

FIG. 3 is a front view illustrating the game board of the pachinko gaming machine according to the embodiment of the present invention;

FIG. 4 is a block diagram illustrating the main control circuit and the sub control circuit structured in the pachinko gaming machine according to the embodiment of the present invention;

FIG. 5 is an explanation view illustrating a command correspondence table in the pachinko gaming machine according to the embodiment of the present invention;

FIG. 6 is an explanation view illustrating displayed screens displayed on the pachinko gaming machine according to the embodiment of the present invention;

FIG. 7 is a flowchart illustrating a controlling process which is conducted in the pachinko gaming machine according to the embodiment of the present invention;

FIG. 8 is a flowchart illustrating a controlling process which is conducted in the pachinko gaming machine according to the embodiment of the present invention;

FIG. 9 is a flowchart illustrating a controlling process which is conducted in the pachinko gaming machine according to the embodiment of the present invention;

FIG. 10 is an explanation view illustrating the state transitions during the controlling process which is conducted in the pachinko gaming machine according to the embodiment of the present invention;

FIG. 11 is a flowchart illustrating a controlling process which is conducted in the pachinko gaming machine according to the embodiment of the present invention;

FIG. 12 is a flowchart illustrating a controlling process which is conducted in the pachinko gaming machine according to the embodiment of the present invention;

FIG. 13 is a flowchart illustrating a controlling process which is conducted in the pachinko gaming machine according to the embodiment of the present invention;

FIG. 14 is a flowchart illustrating a controlling process which is conducted in the pachinko gaming machine according to the embodiment of the present invention;

FIG. 15 is a flowchart illustrating a controlling process which is conducted in the pachinko gaming machine according to the embodiment of the present invention;

FIG. 16 is a flowchart illustrating a controlling process which is conducted in the pachinko gaming machine according to the embodiment of the present invention;

FIG. 17 is a flowchart illustrating a controlling process which is conducted in the pachinko gaming machine according to the embodiment of the present invention;

FIG. 18 is an explanation view illustrating a game board of a pachinko gaming machine according to an embodiment of the present invention;

FIG. 19 is a cross-sectional view illustrating a door and a game board which are configured in a pachinko gaming machine according to an embodiment of the present invention;

FIG. 20 is a perspective view illustrating the overview of a pachi-slot gaming machine according to an embodiment of the present invention; and

FIG. 21 is a perspective view illustrating the overview of a gaming machine according to an embodiment of the present invention.

### DESCRIPTION OF THE EMBODIMENTS

Hereinafter, a preferred embodiment of the present invention will be described on the basis of the drawings.

(Configuration of Gaming Machine)

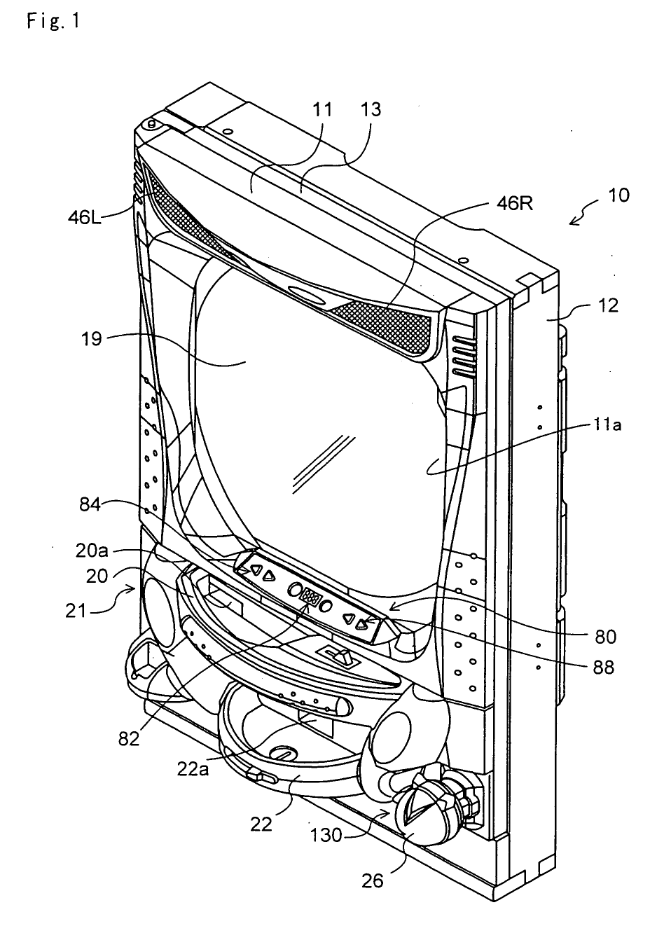

The overview of a gaming machine according to the present embodiment will be described with reference to FIGS. 1 to 3. In the following embodiment, there will be described a case where the present invention is applied to a first type of pachinko gaming machine (also referred to as a “digipachi”), as a preferred embodiment of the gaming machine according to the present invention.

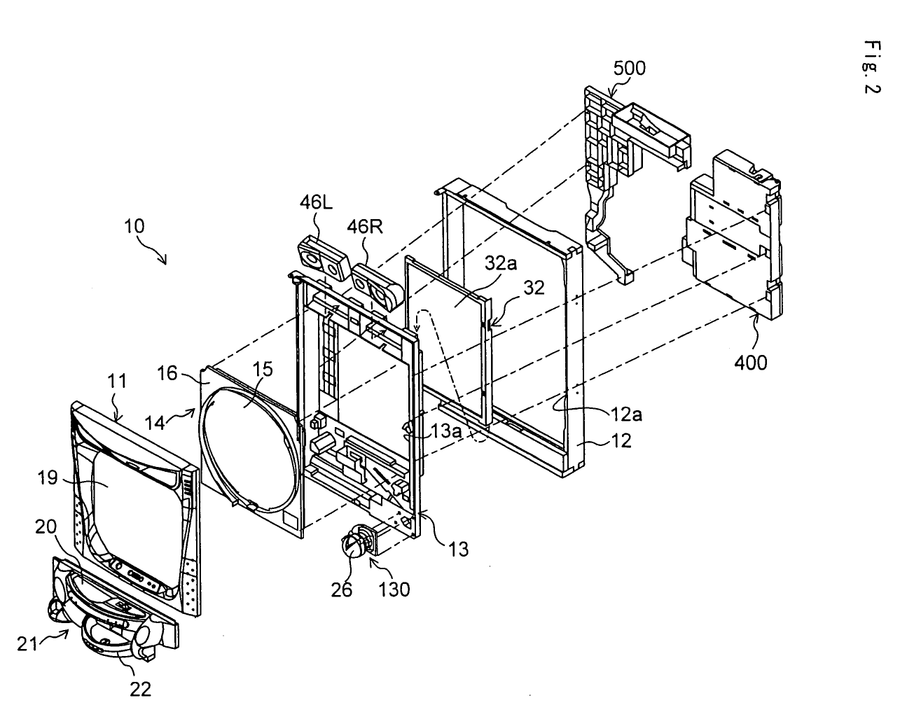

A pachinko gaming machine 10 is constituted by a glass door 11, a wood frame 12, a base door 13, a game board 14, a plate unit 21, a liquid crystal display device 32 for displaying images, a launch device 130 for launching gaming balls, a board unit 400, a ball payout unit 500 for providing game currencies and the like, as illustrated in FIG. 1 and FIG. 2.

As illustrated in FIG. 2, the aforementioned glass door 11 is pivotally mounted to the base door 13 such that it is openable and closable with respect to the base door 13. Further, the glass door 11 has an opening 11a formed at the center thereof, as illustrated in FIG. 1. Further, in the opening 11a, there is a transparent protective glass 19. The protective glass 19 is placed such that it is faced to the front surface of the game board 14, which will be described later, at a state where the glass door 11 is closed. Particularly, while it is necessary only that the protective glass 19 is placed to be faced to at least the entire game region 15, the protective glass 19 may be placed to be faced tothe front surface region 16 (hereinafter, referred to as a game region outside 16) of the game board 14 outside of the game region 15.

Further, a control panel 80 is placed under the opening portion 11a in the glass door 11. The control panel 80 includes a gaming ball renting operation portion 82, a menu operation portion 84 for performing operations such as displaying of a menu screen, menu selection, determination and canceling, a game operation portion 88 for performing operations relating to the progress of games, and the like.

The aforementioned plate unit 21 is placed on the base door 13 such that it is positioned under the glass door 11, as illustrated in FIG. 2. The plate unit 21 includes an upper plate 20 at an upper portion thereof, as illustrated in FIG. 1. Further, a lower plate 22 is provided under the upper plate 20. The upper plate 20 is used for storing, thereon, gaming balls to be launched onto the game region 15 which will be described later. The upper plate 20 and the lower plate 22 include payout openings 20a and 22a, respectively, which are formed therein for renting gaming balls and paying out gaming balls (prize balls) and, in the event that a predetermined payout condition is established, gaming balls stored in the ball payout unit 500, which will be described later, are ejected therefrom.

As illustrated in FIG. 2, the aforementioned launch device 130 is placed on the base door 13 such that it is positioned at the side of the plate unit 21. The launch device 130 includes a launching handle 26 which can be operated by a player, as illustrated in FIG. 1. The launching handle 26 is rotatably provided so that the player can operate the launching handle 26 to progress pachinko games. Further, at the back of the launching handle 26, there are provided a launching motor (not shown), a ball feeding solenoid (not shown) and the like. Further, the player playing games is positioned at the front of the pachinko gaming machine 10 where the player can operate the launching handle 26 and the like. Namely, the player can play games at the front of the pachinko gaming machine 10.

Further, the launching handle 26 includes a touch sensor (not shown), a launch stopping switch (not shown) and the like at the outer peripheral edge thereof. When the touch sensor is touched, the touch sensor detects that the player is grasping the launching handle 26. When the player rotates the launching handle 26 in the clockwise direction while grasping it, the launching motor is fed with electric power according to the rotation angle, which causes gaming balls stored on the upper plate 20 to be successively launched onto the game board 14. Further, even when the launching handle 26 is being rotated, if the launch stopping switch is operated, this will prevent gaming balls from being launched from the launch device 130.

The touch sensor provided on the launching handle 26 may be any type of touch sensor capable of detecting that a player is grasping the launching handle 26, such as an optical detection type touch sensor, a heat detection type touch sensor, or the like.

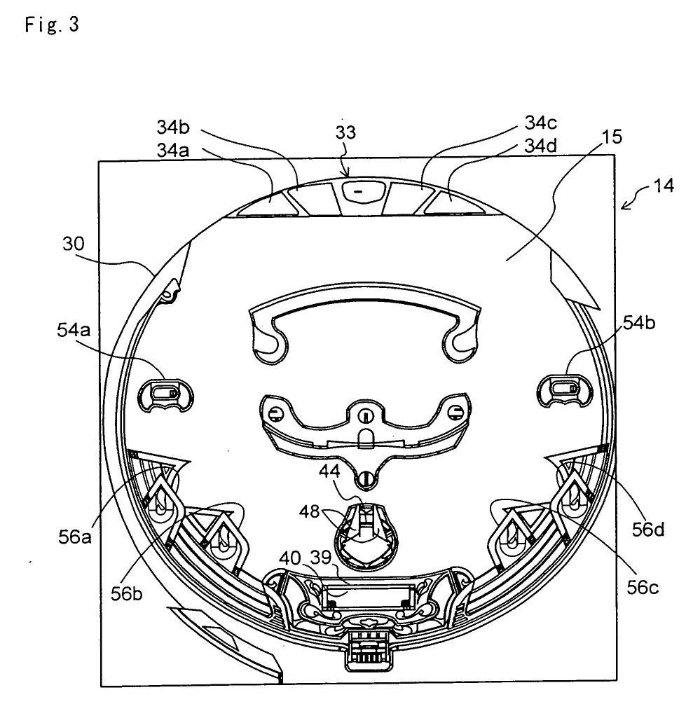

As illustrated in FIG. 2, the aforementioned game board 14 is provided at the front of the base door 13 such that it is positioned behind the protective glass 19 in the glass door 11. The game board 14 is entirely formed from a plate-shaped resin having transparency. As the transparent resin, it is possible to employ various types of materials such as acrylic resin, polycarbonate resin, metacrylate resin. Namely, the game board 14 is entirely or partially formed from a transparent member such that the portion therebehind are viewable. The game board 14 includes, at the front surface thereof, a game region 15 which allows launched gaming balls to roll thereon. As illustrated in FIG. 3, the game region 15 is a region which is surrounded by a guide rail 30 and the like and allows gaming balls to roll thereon. Further, plural obstacle nails (not shown) are provided on the game region 15 of the game board 14. Gaming balls launched from the launch device 130 as described above are moved towards an upper portion of the game board 14 while being guided by the guide rail 30 provided on the game board 14 and, thereafter, they fall towards the lower side of the game board 14 while colliding against the aforementioned plural obstacle nails to change their direction of movement. Further, as will be described in detail later, the game board 14 can be replaced with other game boards by a manager of the game arcade. By replacing the game board, it is possible to provide a variety of games.

At the center of the front surface of the game board 14, there are provided a starting opening 44, a shutter 40 and the like, as illustrated in FIG. 3. On the condition that gaming balls have entered the starting opening 44, variable display of special symbols is executed. As will be described in detail later, according to the result of the variable display of special symbols, the gaming state is shifted to a big-hit gaming state (a specific gaming state, so-called “a big-hit”) which is more relatively advantageous to the player than a normal gaming state. In the event of the occurrence of the big-hit gaming state, the shutter 40 is controlled to be brought into an opened state, which causes a special winning opening 39 to be brought into an open state that can easily receive gaming balls.

As described above, the base door 13 including the glass door 11, the game board 14, the plate unit 21 and the launch device 130 is pivotally mounted to the wood frame 12 as illustrated in FIG. 2. The base door 13 has an opening 13a at the center thereof. Accordingly, the display region 32a of the liquid crystal display device 32 placed behind the base door 13 is viewable through the game board 14 having transparency and the protective glass 19 from the front side. Further, at an upper portion of the base door 13, there are placed speakers 46L and 46R.

Further, at the center of the game board 14, there is placed a special symbol display device 33, as illustrated in FIG. 3. The special symbol display device 33 is a display device capable of 7-segment display and is capable of variable display of special symbols during special symbol games. While the special symbol display device 33 is configured to have a single row of special symbols, the special symbol display device 33 is not limited thereto and may be, for example, configured to have plural symbols rows. The special symbols are symbols consisting of numerical characters, marks and the like and, in the present embodiment, they are numerical characters of “0” to “9” and a picture symbol of “−”.

The “variable display” is a concept of display in a variable manner and is capable of, for example, “variation display” for display in an actually varying manner and “stop display” for display in an actually stopped manner. Further, “variable display” is capable of “derivative display” for displaying identification information as a result of special symbol games. Further, display which starts with the start of variation display and ends with the start of derivative display is defined as a single variable display.

Further, the special symbol display device 33 derivatively displays a special symbol and, in the event that a derivatively displayed special symbol is in a specific display mode (for example, a mode in which any of “0” to “9” is derivatively displayed; a so-called “big-hit display mode”), the gaming state is shifted to a big-hit gaming state (specific gaming state) advantageous to the player. Further, when the derivatively displayed special symbol is in a non-specific display mode (for example, a mode in which “−” is derivatively displayed; a so-called “non-hit mode”), the gaming state is not shifted to a big-hit gaming state.

Further, in the event that the derivatively displayed special symbol is in a special display mode (for example, a mode in which “1”, “3”, “5”, “7” or “9” is derivatively displayed; a so-called “special big-hit display mode”) out of specific display modes, the gaming state is shifted to a big-hit gaming state advantageous to the player and, after the end of the big-hit gaming state, the gaming state is shifted to a probability changing state. On the other hand, if the derivatively displayed special symbol is in a non-special display mode (for example, a mode in which “0”, “2”, “4”, “6” or “8” is derivatively displayed; a so-called “ordinary big-hit display mode”) which is not a special display mode, out of specific display modes, the gaming state is shifted to a big-hit gaming state advantageous to the player and, after the end of the big-hit gaming state, the gaming state is shifted to a normal gaming state which is relatively disadvantageous to the player.

In the aforementioned probability changing state, the probability that the gaming state is shifted to a big-hit gaming state is increased to be relatively higher than in a normal gaming state. Further, a special big-hit gaming state refers to a gaming state as follows; in the event that a derivatively displayed special symbol is in a special display mode, the gaming state is shifted to a big-hit gaming state and, after the end of the big-hit gaming state, the gaming state is shifted to a probability changing state. Further, an ordinary big-hit gaming state refers to a gaming state as follows; in the event that a derivatively displayed special symbol is in a non-special display mode, the gaming state is shifted to a big-hit gaming state and, after the end of the big-hit gaming state, the gaming state is shifted to a normal gaming state.

Further, in a special big-hit during which a big-hit gaming state occurs and then a probability changing state occurs, the upper limit of the number of rounds, which is controlled during the big-hit gaming state, is set to 15 rounds. Namely, the gaming state is shifted to a first big-hit gaming state which is relatively advantageous to the player. On the other hand, in an ordinary big-hit gaming state during which a probability changing state does not occur after the end of a big-hit gaming state, the upper limit of the number of rounds, which is controlled during the big-hit gaming state, is set to 2 rounds.

The aforementioned liquid crystal display device 32 is placed on the base door 13, as illustrated in FIG. 2. The liquid crystal display device 32 includes a display region 32a for displaying images relating to games. The liquid crystal display device 32 is placed behind (at the back surface side of) the game board 14 with the opening 13a interposed therebetween. The liquid crystal display device 32 is placed such that the display region 32a is overlaid in the depthwise direction on all or a portion of the game board 14 at the back surface side thereof, with the opening 13a interposed therebetween. The display region 32a of the liquid crystal display device 32 displays, in predetermined modes, images relating to various types of games, such as decoration symbols which are variably displayed along with variable display of special symbols during special symbol games, background images relating to games, and effect images. Namely, the liquid crystal display device 32 displays effect images relating to games. In other words, the liquid crystal display device 32 includes the display region 32a for displaying effect images relating to games, in such a manner that they are viewable.

Further, the liquid crystal display device 32 variably displays decoration symbols in association with plural symbol rows (three rows in the present embodiment), along with the variable display of special symbols on the special symbol display device 33. In other words, the liquid crystal display device 32 variably displays decoration symbols in the respective symbols rows (display rows). Decoration symbols are derivatively displayed in the plural symbol rows and, in the event that the variable display of special symbols results in a specific display mode on the special symbol display device 33, the combination of derivatively displayed plural decoration symbols form a specific combination (for example, the display mode comes into a mode in which any one of “0” to “9” is derivatively displayed in all the plural symbol rows; a so-called “big-hit display mode”), and the gaming state is shifted to a big-hit gaming state advantageous to the player. Further, in the event that the variable display of special symbols on the special symbol display device 33 results in a special big-hit display mode, the combination of derivatively displayed plural decoration symbols form a special combination (for example, the display mode comes into a mode in which any one of “1”, “3”, “5”, “7” and “9” is derivatively displayed in all the plural symbol rows; a so-called “special big-hit display mode”), out of specific combinations of decoration symbols, and the gaming state is shifted to a big-hit gaming state advantageous to the player and, after the end of the big-hit gaming state, the gaming states is shifted to a probability changing state. On the other hand, in the event that the variable display of special symbols on the special symbol display device 33 results in a ordinary big-hit display mode, the combination of derivatively displayed plural decoration symbols forms a non-special combination are (for example, the display mode comes into a mode in which any one of “0”, “2”, “4”, “6” and “8” is derivatively displayed in all the plural symbol rows; a so-called “ordinary big-hit display mode”), wherein the non-special combination is not a special combination of decoration symbols, out of specific combinations of decoration symbols. Thus, the gaming state is shifted to a big-hit gaming state advantageous to the player and, after the end of the big-hit gaming state, the gaming states is shifted to a normal gaming state. As described above, the liquid crystal display device 32 variably displays decoration symbols (exemplary identification information). Further, in the present embodiment, the liquid crystal display device 32 corresponds to exemplary variably displaying means. The liquid crystal display device 32 further displays background images, effect images and the like for executing effects, in addition to decoration symbols as described above.

As described above, when the player plays games at the front of the pachinko gaming machine 10, namely when the glass door 11 is closed, the liquid crystal display device 32 is placed behind the transparent game board 14, and also the transparent protective glass 19 is placed at the front of the game board 14. Therefore, the player can see images, being displayed to the display region 32a of the liquid crystal display device 32 through the transparent game board 14 and the transparent protective glass 19.

Accordingly, the liquid crystal display device 32 is placed behind the transparent game board 14 and the display region 32a of the liquid crystal display device 32 executes various types of effects, which enables providing novel display effects which have not been provided by conventional gaming machines, thereby enhancing enjoyment. Further, in conventional gaming machines, the size of the game region may be possibly reduced with increasing size of the display region. Further, if various types of images are displayed without increasing the size of the display region, the player can not easily see the images. Therefore, since various types of display effects can be executed, it is possible to execute various types of effects regardless of the size of the display region of the liquid crystal display device 32, which can enhance enjoyment. Further, since there is provided a gap between the game board 14 and the liquid crystal display device 32 placed behind the game board 14, impacts caused by the adjustment of obstacle nails are hardly transferred to the liquid crystal display device 32, which can prevent the liquid crystal display device 32 from being damaged, thereby increasing the service life of the liquid crystal display device 32. Further, the liquid crystal display device 32 may be provided with holes for placing and the like of entry-starting accessories, winning openings, ball flow channels, and reels.

While, in the present embodiment, the liquid crystal display device 32 constituted by a liquid crystal display panel is employed as an image display portion, the present invention is not limited thereto and may employ other types of image display portions such as, for example, a Braun tube including a CRT (Cathode Ray Tube), dot LEDs (Light Emitting Diodes), segment LEDs, ELs (Electronic Luminescent), plasma or the like.

The aforementioned wood frame 12 is a frame member made of wood and the base door 13 is pivotally mounted to the front side thereof. While, in the present embodiment, the wood frame 12 made of wood is employed, the present invention is not limited thereto and may employ other types of frame members such as a metal frame member, a resin frame member. Further, the wood frame 12 has an opening 12a at the center thereof. In the opening 12a, there are placed the aforementioned base door 13, the liquid crystal display device 32, the board unit 400 which will be described in detail later, the ball payout unit 500 and the like.

The aforementioned board unit 400 is pivotally mounted to the back side of the base door 13. The board unit 400 incorporates various types of boards (not shown) provided with circuits for controlling the pachinko gaming machine 10 and, these boards are covered with board casings (not shown).

The aforementioned ball payout unit 500 is pivotally mounted to the back side of the base door 13. The ball payout unit 500 is constituted by a ball storage tank (not shown) for storing gaming balls and a ball channel casing (not shown) and is configured to direct gaming balls stored in the ball storage tank to the aforementioned payout openings 20a and 22a.

On the game region 15 of the aforementioned game board 14, there are provided various types of entry-starting accessories. Although an exemplary entry-starting accessory will be described later with reference to FIG. 3, the present invention is not limited thereto.

For example, at an upper center portion on the game region 15 of the game board 14 there is provided the special symbol display device 33.

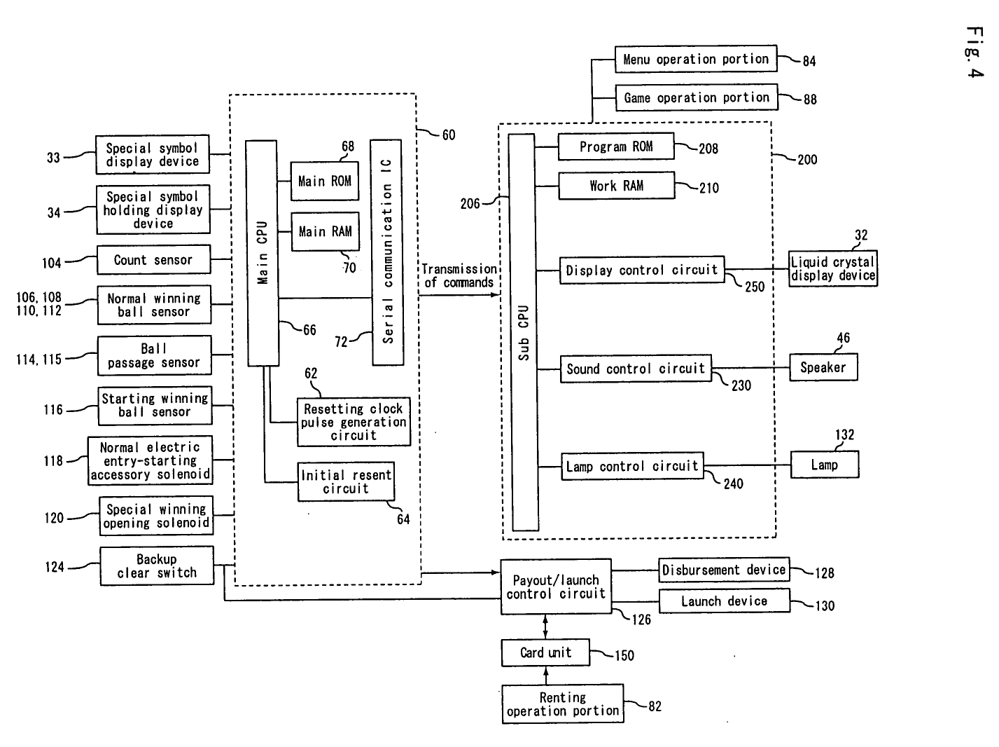

Further, at an upper portion of the game board 14, there are provided special symbol holding display devices 34a to 34d (designated by a reference character of 34 in FIG. 4), which display the number of holds in a special symbol game.

Further, on the game region 15 of the game board 14, at upper positions thereof, there are provided ball passage detection devices 54a and 54b. On the condition that the ball passage detection devices 54a and 54b have detected gaming balls having passed their periphery, blade members (so-called normal electric entry-starting accessories, hereinafter, also referred to as normal electric accessories) 48 provided at either sides of the starting opening 44 which will be described later are brought into an opened state from a closed state, which causes gaming balls to easily enter the starting opening 44. Further, after the elapse of a predetermined time since the blade member 48 was brought into an opened state, the blade member 48 is brought into a closed state, which causes gaming balls not to easily enter the starting opening 44.

Further, at lower positions on the game region 15 of the game board 14, there are provided normal winning openings 56a and 56b for gaming balls.

Further, at a lower position of the game region 15 of the game board, there is provided a shutter 40 which is openable and closable relative to the special winning opening 39. As described above, in the event that a special symbol is derivatively displayed in a specific display mode, the gaming state is shifted to a big-hit gaming state and the shutter 40 is driven into an opened state (a first state) which can easily receive gaming balls. Further, the special winning opening has a normal region (not shown) including a count sensor 104 (see FIG. 4), and the shutter 40 is kept driven into the opened state until a predetermined number of gaming balls (for example, 10 gaming balls) have passed through the normal region or until a predetermined time (for example, 30 seconds) has elapsed. Namely, when the predetermined number of gaming balls have entered the special winning opening or the predetermined time has elapsed at the opened state, the special winning opening is brought into a closed state (a second state) which can not easily receive gaming balls. Then, the shutter 40 which has been brought into the closed state from the opened state is driven into an opened state again, on the condition that the number of rounds has not reached its upper limit.

Further, above the shutter 40, there is provided the starting opening 44 including a starting winning ball sensor 116 (see FIG. 4). In the event that a gaming ball enters the starting opening 44, a special symbol game which will be described later is started, and the gaming state is shifted to a variation display state where special symbols are variably displayed. In the present embodiment, variable display is started mainly on the condition that a gaming ball has entered the starting opening 44 (a gaming ball has passed through the starting region), and such condition can be described as a predetermined variable display starting condition. Namely, if a predetermined variable display starting condition is established (on the condition that a gaming ball has passed through the starting region), variable display of special symbols is performed. While, in the present embodiment, variable display is started on the condition that a gaming ball has entered the starting opening 44 is described as a predetermined variable display starting condition, the present invention is not limited thereto and may employ other conditions.

Further, in the event that a gaming ball enters the starting opening 44 when special symbols are being variably displayed during special symbol games, the execution (start) of the variable display of special symbols based on the entry of the gaming ball into the starting opening 44 is held until a special symbol is derivatively displayed after the variable display of special symbols. Namely, in the case where a predetermined variable display starting condition is not established (a predetermined variable display holding condition is established) even when a predetermined variable display executing condition is established, the execution (start) of variable display of special symbols is held until the predetermined variable display starting condition is established. If a special symbol is derivatively displayed at the state where the execution of variable display of special symbols has been held, then the execution of variable display of special symbols which has been held is started. Further, when a special symbol is derivatively displayed, variable display of special symbols is executed a single time. For example, when the execution of variable display of special symbols has been held three times, if a special symbol is derivatively displayed, then variable display of special symbols will be executed a single time out of the number of held variable displays and the remaining two variable displays will be held. Further, there is set an upper limit to the number of times the execution of variable display of special symbols can be held and, for example, variable display of special symbols can be held up to four times as an upper limit. When variable display of identification information is held during special symbol games as described above, the special symbol holding display devices 34 indicate the number of holdings.

While, in the present embodiment, variable display of special symbols can be held up to four times as an upper limit, the present invention is not limited thereto and may employ other aspects. For example, variable display of special symbols may be held up to a single time or plural times as an upper limit or may be held up to infinity. As a matter of course, it is not necessary that holding of variable display of special symbols is performed.

(Electric Structure of Gaming Machine)

FIG. 4 illustrates a block diagram illustrating the control circuit of the pachinko gaming machine 10 according to the present embodiment.

The pachinko gaming machine 10 is mainly constituted by a main control circuit 60 as a game control means and a sub control circuit 200 as an effect control means. The main control circuit 60 controls of games. The sub control circuit 200 controls of effects in accordance with the progress of games.

As illustrated in FIG. 4, a main control circuit 60 includes a main CPU 66 as control means, a main ROM (Read Only Memory) 68, and a main RAM (Random Access Memory) 70.

The main ROM 68, the main RAM 70 and the like are connected to the main CPU 66 and, the main CPU 66 has the function of performing various types of processes in accordance with programs stored in the main ROM 68. As described above, the main CPU 66 functions as various means as will be described later.

The main ROM 68 stores programs for controlling the operations of the pachinko gaming machine 10 through the main CPU 66 and also stores various types of tables such as a big-hit determination table which is referred to in performing a big-hit determination through random number lottery, and an effect condition selection table which is referred to in selecting an effect. Detailed description of programs will be provided later.

While, in the present embodiment, the main ROM 68 is employed as a medium for storing programs, tables and the like, the present invention is not limited thereto and may employ other types of storage mediums readable by computers including control means. For example, it is possible to store programs, tables and the like in a storage medium such as a hard disk device, a CD-ROM, a DVD-ROM, a ROM cartridge. Further, these programs may be downloaded and stored in the main RAM 70 or the like after power up, instead of being prestored. Also, respective programs may be stored in different storage mediums. While, in the present embodiment, the main CPU 66, the main ROM 68 and the main RAM 70 are separately provided, they may be integrated into an one-chip microcomputer.

The main RAM 70 has the function of storing various flags and variable values, as a temporal storage region of the main CPU 66. As concrete examples of data stored in the main RAM 70, there is data as follows.

In the main RAM 70, there are positioned a control state flag, a high probability flag, a big-hit determination random number counter, a big-hit symbol determination-random number counter, an effect condition selection random number counter, a special winning opening open frequency counter, a special winning opening entry counter, a waiting time timer, a special winning opening open time timer, variable values relating to outputs including data and the like indicative of the number of holdings during special symbol games, data, variable values and the like for sending commands to the sub control circuit 200 which will be described later.

The control state flag indicates the control state during special symbol games. The high probability flag indicates whether or not the probability that the gaming state is shifted to a big-hit gaming state should be set to be relatively higher.

The big-hit determination random number counter is for determining whether or not of special symbols have won a big-hit. The big-hit symbol determination random number counter is for determining a special symbol to be derivatively displayed if it is determined that special symbols have won a big-hit. The effect condition selection random number counter is for determining the variation display pattern of special symbols and decoration symbols. The main CPU 66 updates these counters by successively incrementing their count values by one and storing the count values, and random numbers are extracted from the respective counters at predetermined timing for executing various types of functions of the main CPU 66. While, in the present embodiment, the random number counters are provided as described above and the main CPU 66 updates the random number counters by incrementing their count values by one and storing them in accordance with programs, the present invention is not limited thereto and a separate device such as a random number generator may also be provided. Further, there may be provided a reach determination random number counter for determining whether or not reach has occurred in the event of a non-hit.

The waiting time timer is provided for syncronization between processes conducted by the main control circuit 60 and the sub control circuit 200. Further, the special winning opening open time timer is for measuring the time during which the shutter 40 is driven to keep the special winning opening 39 open. Further, while in the present embodiment the timers are updated and stored at predetermined intervals, in the main RAM 70, such that their count values are subtracted by the predetermined interval, the present invention is not limited thereto and the CPU and the like may include timers.

The special winning opening open frequency counter indicates the number of times the special winning opening 39 has been opened during a big-hit gaming state (so-called, “the number of rounds”). Further, the special winning opening entry counter indicates the number of gaming balls which have entered the special winning opening 39 and passed through the counter sensor 104 during a single round. The data indicative of the number of holds indicates the number of times a special symbol under the state of variable display has been held. The variable display is held when varying displaying of special symbols can not be executed even if a gaming ball enters the starting opening 44.

While, in the present embodiment, the main RAM 70 is utilized as a temporal storage region for the main CPU 66, the present invention is not limited thereto and may employ any readable and writable storage medium.

Further, the main control circuit 60 includes a reset clock pulse generation circuit 62 for generating clock pulses with a predetermined frequency, an initial reset circuit 64 for generating a reset signal at power-up, and a serial communication IC 72 for sending commands to the sub control circuit 200 which will be described later. The reset clock pulse generation circuit 62, the initial reset circuit 64 and the serial communication IC 72 are connected to the main CPU 66. Further, the reset clock pulse generation circuit 62 generates clock pulses at predetermined intervals (for example, at 2-miliseconds intervals), in order to conduct a system timer interruption process which will be described later. Further, the serial communication IC 72 corresponds to a transmission means for transmitting various types of commands to the sub control circuit 200 (various types of means included in the sub control circuit 200).

Further, various types of devices are connected to the main control 60 and, for example, the special symbol display device 33, the special symbol holding display device 34, the count sensor 104, normal winning ball sensors 106, 108, 110 and 112, ball passage sensors 114 and 115, a starting winning ball sensor 116, a normal electric entry-starting accessory solenoid 118, a special winning opening solenoid 120, a backup clear switch 124 and the like are connected thereto, as illustrated in FIG. 4.

The special symbol display device 33 conducts variable display of special symbols during special symbol games, in accordance with signals from the main control circuit 60.

The special symbol holding display device 34 indicates the number of times variable display of special symbols has been held during special symbol games, in accordance with signals from the main control circuit 60.

The counting sensor 104 is provided in the special winning opening 39. In the event that a gaming ball passes through the normal region of the special winning opening 39, the counting sensor 104 sends a predetermined detection signal to the main control circuit 60.

The regular winning ball sensors 106, 108, 110 and 112 are provided in the regular winning openings 56a to 56d. In the event that a gaming gall passes through the normal winning openings 56a to 56d, the regular winning ball sensors 106, 108, 110 and 112 send a predetermined detection signal to the main control circuit 60.

The passing ball sensors 114 and 115 are provided in the ball passage detectors 54a and 54b. In the event that a gaming ball passes through the ball passage detectors 54a and 54b, the passing ball sensors 114 and 115 send a predetermined detection signal to the main control circuit 60.

The starting winning ball sensor 116 is provided in the starting opening 44. In the event that a gaming ball enters the starting opening 44, the starting winning ball sensor 116 sends a predetermined detection signal to the main control circuit 60.

The normal electric entry-starting accessory solenoid 118 is connected to the blade members 48 through a link member (not shown) and brings the blade members 48 into the opened state or the closed state, in accordance with driving signals sent from the main CPU 66.

The special winning opening solenoid 120 is connected to the shutter 40 illustrated in FIG. 1 and drives the shutter 40 to open or close the special winning opening 39, in response to driving signals sent from the main CPU 66.

The backup clearing switch 124 is incorporated in the pachinko gaming machine 10 and has the function of clearing data which was backed up at the time of power-off and the like, in accordance with operations of an administrator of the game arcade.

The payout/launching control circuit 126 is connected to the main control circuit 60. A disbursement device 128 for disbursing gaming balls, a launch device 130 used for launching gaming balls and a card unit 150 are connected to the payout/launching control circuit 126. More specifically, the payout/launching control circuit 126 includes at least a CPU (not shown) for controlling this payout/launching control circuit 126, a ROM (not shown) which stores programs for causing the CPU to execute a process and a RAM (not shown) which is an operation region for the CPU. Further, the rental operating portion 82 is connected to the card unit 150 and, thus, the card unit 150 is supplied with operation signals in accordance with operations performed on the rental operating portion 82.

The payout/launching control circuit 126 receives ball winning control commands sent from the main control circuit 60 and ball rental control signals sent from the card unit 150 and transmits predetermined signals to the disbursement device 128 to cause the disbursement device 128 to disburse gaming balls. Further, the payout/launching control circuit 126 sends launching signals to the launch device 130 for controlling it to launch gaming balls. Further, the disbursement device 128 is employed as exemplary payout means that pays out gaming mediums in the event that launched (introduced) gaming mediums pass through a predetermined region. Further, the payout/launching control circuit 126 is employed as exemplary payout control means for driving and controlling the payout means.

The launch device 130 includes devices for launching gaming balls, such as the aforementioned launching motor, the touch sensor and the like. When the player grasps the launching handle 26 and rotates it in the clockwise direction, the launching motor is fed with electric power according to the angle of rotation to successively launch gaming balls stored on the upper plate 20 towards the game board 14. Further, the aforementioned launch device 130 is employed as an exemplary launch device for launching gaming mediums in accordance with operations performed by the player. Further, the payout/launching control circuit 126 is employed as exemplary launching control means for driving and controlling the launching means.

Further, the sub control circuit 200 is connected to the serial communication IC 72. The sub control circuit 200 controls the display on the liquid crystal display device 32, controls sounds to be generated from the speakers 46 (46L and 46R in FIG. 1) and also controls the lamps 132 including decoration lamps (not shown) and the like.

While, in the present embodiment, the main control circuit 60 sends commands to the sub control circuit 200 while the sub control circuit 200 is not capable of sending signals to the main control circuit 60, the present invention is not limited thereto and the sub control circuit 200 may be configured to be capable of sending signals to the main control circuit 60.

The sub control circuit 200 is constituted by a sub CPU 206, a program ROM 208 as a storage means, a work RAM 210, a display control circuit 250 for controlling the display on the liquid crystal display device 32, a sound control circuit 230 for controlling sounds to be generated from the speakers 46, and a lamp control circuit 240 for controlling the lamps 132 including decoration lamps and the like. The sub control circuit 200 controls effects, along with the progress of games, in accordance with commands from the main control circuit 60. Further, a menu operation portion 84, a game operation portion 88 and the like, which can be operated by the player, are connected to the sub control circuit 200, and the sub control circuit 200 is supplied with operation signals according to operations performed on these operating portions (operation state).

The program ROM 208, the work RAM 210 and the like are connected to the sub CPU 206. The sub CPU 206 has the function of executing various types of processes, in accordance with programs stored in the program ROM 208. Particularly, the sub CPU 206 controls the sub control circuit 200, in accordance with various commands sent from the main control circuit 60. The sub CPU 206 functions as various means as will be described later.

The program ROM 208 stores programs for controlling game effects in the pachinko gaming machine 10 through the sub CPU 206 and also stores various types of tables such as a table used for making determinations relating to effects. Detailed description of programs will be provided later.

While, in the present embodiment, it is configured to utilize the program ROM 208 as storage means for storing programs, tables and the like, the present invention is not limited thereto and may employ any other types of storage media which are readable by computers including control means and, for example, such programs, tables and the like may be stored in a storage medium such as a hard disk device, a CD-ROM, a DVD-ROM, a ROM cartridge. As a matter of course, the main ROM 68 may be utilized as a storage medium. Also, these programs may be downloaded after power-up and then recorded in the work RAM 210 or the like, rather than be pre-recorded. Also, the respective programs may be recorded in different recording media.

The work RAM 210 has the function of storing various flags and variable values, as a temporal storage region of the sub CPU 206. For example, there are positioned, therein, an effect display selection random number counter and the like used for selecting effect patterns, various types of variable values and the like.

Further, while, in the present embodiment, the work RAM 210 is utilized as a temporal storage region of the sub CPU 206, the present invention is not limited thereto and may employ any read-and-write storage media.

The display control circuit 250 is a circuit for controlling the display on the liquid crystal display device 32 and is constituted by an image data processor (hereinafter, referred to as a VDP), an image data ROM which stores data for generating various types of image data, a frame buffer for buffering image data, a D/A converter for converting image data into image signals, and the like.

The display control circuit 250 is a device capable of conducting various types of process for causing the liquid crystal display device 32 to display images, in accordance with data supplied from the sub CPU 206.

The display control circuit 250 temporarily stores, in the frame buffer, image data to be displayed on the liquid crystal display device 32, including various types of image data such as decoration symbol image data indicating decoration symbols, background image data, effect image data, according to the image display order supplied from the sub CPU 206. Then, the display control circuit 250 supplies image data stored in the frame buffer to the D/A converter, at predetermined timing. The D/A converter converts the image data into image signals and supplies the image signals to the liquid crystal display device 32 at predetermined timing to cause the liquid crystal display device 32 to display images. Namely, the display control circuit 250 conducts controls for causing the liquid crystal display device 32 to display images relating to games.

Further, the sound control circuit 230 is constituted by a sound source IC for performing control relating to sound, an audio data ROM for storing various types of sound data, and an amplifier for amplifying sound signals (hereinafter, referred to as an AMP) and the like.

The sound source IC controls sounds to be generated from the speakers 46. The sound source IC selects one sound data from plural sound data stored in the sound data ROM, in accordance with sound generating commands supplied from the sub CPU 206. Further, the sound source IC reads the selected sound data from the sound data ROM, converts the sound data into predetermined sound signals and supplies the sound signals to the AMP. The AMP amplifies the sound signals and causes the speakers 46 to generate sounds.

The lamp control circuit 240 is constituted by a drive circuit for generating lamp control signals, a decoration data ROM which stores plural types of lamp decoration patterns, and the like.

(Command Correspondence Table)

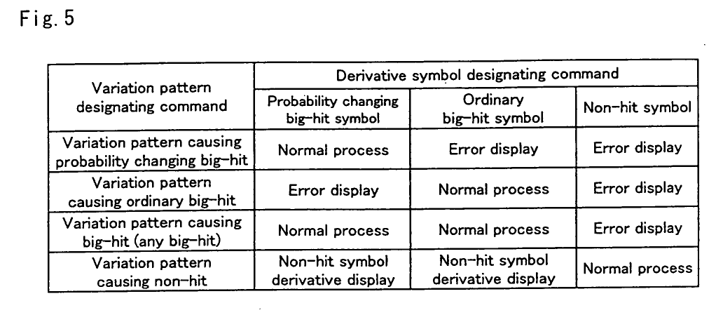

With reference to FIG. 5, there will be described a command correspondence table stored in the program ROM 208 in the pachinko gaming machine 10 having the aforementioned configuration. Also, it is not necessary that the command correspondence table which will be described later is stored in the program ROM 208, provided that data and programs which provide such functions are stored in the program ROM 208.

The command correspondence table stored in the program ROM 208 is a table usable for determining whether or not the combination of a variation pattern designation command and a derivative symbol designation command is a normal combination or a combination at the time of an error. Such a variation pattern designation command is a command which indicates the variable display pattern of identification information and identifies whether or not variable display of identification information results in a specific display mode or a special display mode. Further, such a derivative symbol designation command is a command which indicates the result of variable display of identification information.

In the command correspondence table, as illustrated in FIG. 5, there are stored received variation pattern designation commands, received derivative symbol designation commands and processes corresponding to these commands, in association with one another.

More specifically, in the case where a variation pattern designation command indicative of a variation pattern of a probability changing big-hit is received, if a derivative symbol designation command for derivatively displaying probability changing big-hit symbols is received, then normal processing is conducted. However, in this case, if a derivative symbol designation command for derivatively displaying ordinary big-hit symbols is received or if a derivative symbol designation command for derivatively displaying non-hit symbols is received, then an error displaying process is executed.

Also, in the case where a variation pattern designation command indicative of a variation pattern of an ordinary big-hit is received, if a derivative symbol designation command for derivatively displaying probability changing big-hit symbols is received and if a derivative symbol designation command for derivatively displaying non-hit symbols is received, then an error displaying process is conducted. However, in this case, if a derivative symbol designation command for derivatively displaying ordinary big-hit symbols is received, a normal processing is conducted.

Also, in the case where a variation pattern designation command indicative of a variation pattern of a big-hit, which is commonly usable for a probability changing big-hit and an ordinary big-hit, is received, if a derivative symbol designation command for derivatively displaying probability changing big-hit symbols is received and if a derivative symbol designation command for derivatively displaying ordinary big-hit symbols is received, then normal processing is conducted. However, in this case, if a derivative symbol designation command for derivatively displaying non-hit symbols is received, an error displaying process is conducted.

Also, in the case where a variation pattern designation command indicative of a variation pattern of a non hit is received, if a derivative symbol designation command for derivatively displaying probability changing big-hit symbols is received and if a derivative symbol designation command for derivatively displaying ordinary big-hit symbols is received, then a non-hit symbol derivatively displaying process is conducted. However, in this case, if a derivative symbol designation command for derivatively displaying non-hit symbols is received, a normal processing is conducted.

The aforementioned normal processing is a process for variably displaying decoration symbols in the variation pattern corresponding to the received variation pattern designation command and for derivatively displaying symbols corresponding to the derivative symbol designation command. Further, the error processing is a process for variably displaying decoration symbols in the variation pattern corresponding to the received variation pattern designation command and for displaying a display error image, instead of derivatively displaying a symbol corresponding to the derivative symbol designation command. The non-hit symbol derivatively displaying process is a process for variably displaying decoration symbols in the variation pattern corresponding to the received variation pattern designation command and for derivatively displaying a non-hit symbol rather than a symbol corresponding to the derivative symbol designation command.

Namely, the program ROM 208, which stores the aforementioned command correspondence table, stores data capable of identifying the combination of a variation pattern designation command (an example of a variable display pattern command) and a derivative symbol designation command (an example of a variable display result command) at the time of an error. The program ROM 208 corresponds to exemplary command combination data storage means.

As described above, there is stored data capable of identifying the combination of a variable display pattern command and a variable display result command at the time of an error. Further, the combination of the received variable display pattern command and the variable display result command is determined whether or not it is a combination at the time of an error. As a result, on the basis of the stored data, if the combination of the received variable display pattern command and the variable display result command is determined to be a combination at the time of an error, the result is determined as a predetermined error, and the result of the determination is notified. Accordingly, for example, if a transmitted variable display pattern command and a transmitted variable display result command are accidentally changed due to noises or the like, thus resulting in an abnormal combination of the identification information variably displaying pattern and the result of variable display of identification information, this will be notified as a predetermined error, which can enhance the reliability of the derivatively displayed identification information without inducing confusion about games, thereby preventing the reduction of enjoyment.

Further, on the condition that variable display of identification information has resulted in a special display mode out of specific display modes, the gaming state is shifted to a special gaming state where variable display of identification information can readily result in a specific display mode with higher probability, after the end of the big-hit gaming state, and also a variable display pattern command as described above is sent, wherein the variable display pattern command identifies whether or not the variable display of identification information should result in a special display mode. Accordingly, for example, even if the received commands are a variable display pattern command for causing variable display of identification information to result in a special display mode and a variable display result command for causing variable display of identification information to result in a non-special display mode, thus indicating an abnormal combination of the identification information variably displaying pattern and the result of variable display of identification information, this will be indicated as a predetermined error. This can enhance the reliability of the derivatively displayed identification information without inducing confusion about games, thereby preventing the reduction of enjoyment.

Further, if the combination of received commands is determined to be a variable display pattern command for causing variable display of identification information not to result in a specific display mode and a variable display result command for causing variable display of identification information to result in a specific display mode, then a result of variable display of identification information which is not in a specific display mode is derivatively displayed. Accordingly, if the combination of received commands is a variable display pattern command for causing variable display of identification information not to result in a specific display mode and a variable display result command for causing variable display of identification information to result in a specific display mode, this will not be notified as an error. Even when a result of variable display of identification information which is not in a specific display mode is derivatively displayed, there is a lower possibility that the player can notice the occurrence of an error, which can smoothly progress games and prevent the reduction of the reliability of the derivatively displayed identification information, thereby preventing the reduction of enjoyment.

(Description of Displayed Screens)

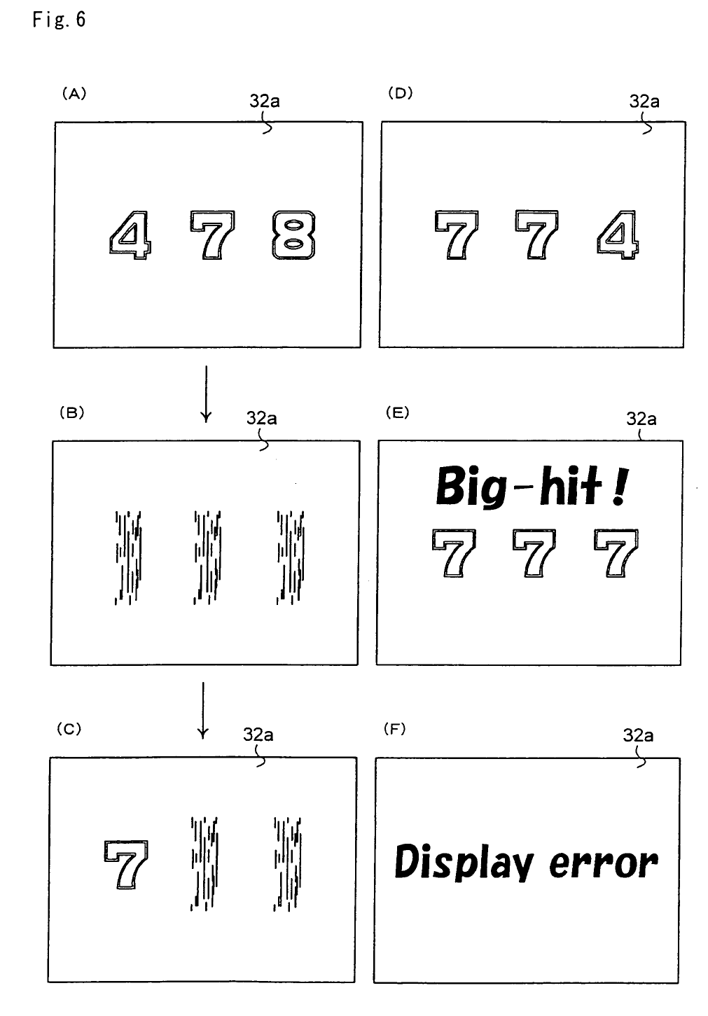

Further, with reference to FIG. 6, there will be described displayed screens relating to special symbol games which are executed in the aforementioned configuration.

(Description of Special Symbol Game)

In the special symbol display device 33, as illustrated in FIG. 3, special symbols are variably displayed. More specifically, when a special symbol is being derivatively displayed, if a predetermined variable display starting condition is established, then variable display of special symbols is executed and, then, a special symbol is stopped and displayed. If the derivatively displayed special symbol is in a non-specific display mode (for example, a mode in which none of “0” to “9” is displayed; “−”), the gaming state is not shifted to a big-hit gaming state and the current gaming state such as a normal gaming state is maintained. If the derivatively displayed special symbol is in a specific display mode (for example, any of “0” to “9”), the gaming state is shifted to a big-hit gaming state.

Further, on the display region 32a of the liquid crystal display device 32, decoration symbols are variably displayed in plural rows for decorating the special symbols on the special symbol display device 33. More specifically, when a special symbol is derivatively displayed, decoration symbols are also derivatively displayed, as illustrated in FIG. 6(A). Then, if the aforementioned predetermined variable display starting condition is established, decoration symbols are also variably displayed similarly to special symbols, as illustrated in FIG. 6(B). Then, before a special symbol is derivatively displayed, a decoration symbol is stopped and displayed in the left row as illustrated in FIG. 6(C) and, thereafter, a decoration symbol is stopped and displayed in the right row. Then, at the timing when a special symbol is derivatively displayed, a decoration symbols is stopped and displayed in the center row and, thus, these decoration symbols have been derivatively displayed.

Further, there is a relation between derivatively displayed decoration symbols are a derivatively displayed special symbol. More specifically, in the case where the special symbol is “−”, the decoration symbols are in a non-specific display mode (for example, a mode in which the same symbol is not displayed in all the three rows). In the case where the special symbol is any one of “0” to “9”, the decoration symbols are in a specific display mode (for example, a mode in which the same symbol is displayed in all the three rows). Namely, when decoration symbols are statically displayed in all the rows, if the derivatively displayed decoration symbols in the plural rows is in a non-specific display mode (for example, a mode in which the same symbol is not displayed in all the three rows) as illustrated in FIG. 6(D), a special symbol of “−” is derivatively displayed, and the current gaming state such as a normal gaming state is maintained. On the other hand, if the decoration symbols in the plural rows are brought into a reach state and, thus, they are in a specific display mode (for example, a mode in which the same symbol is displayed in all the three rows) as illustrated in FIG. 6(E), any special symbol out of “0” to “9” is derivatively displayed and the gaming state is shifted to a big-hit gaming state.

Further, in the event of the occurrence of an error, in which a variation pattern designation command and a derivative symbol designation command, as will be described later, is a combination at the time of an error, a display error image is displayed as illustrated in FIG. 6(F) instead of derivative displaying the result of variable display of identification information. As described above, if a predetermined error is determined, the result of the determination is indicated. Accordingly, for example, if a transmitted variable display pattern command and a transmitted variable display result command are accidentally changed due to noises or the like, thus resulting in an abnormal combination of the identification information variably displaying pattern and the result of variable display of identification information, this will be indicated as a predetermined error, which can enhance the reliability of the derivatively displayed identification information without inducing confusion about games, thereby preventing the reduction of enjoyment.

Further, as will be described in detail later, if a variation pattern designation command for derivatively displaying in a non-specific display mode and a derivative symbol designation command for derivatively displaying in a specific display mode are received, as illustrated in FIG. 6(D), decoration symbols are derivatively displayed in a non-specific display mode, instead of displaying a display error image.

(Movement of the Gaming Machine)

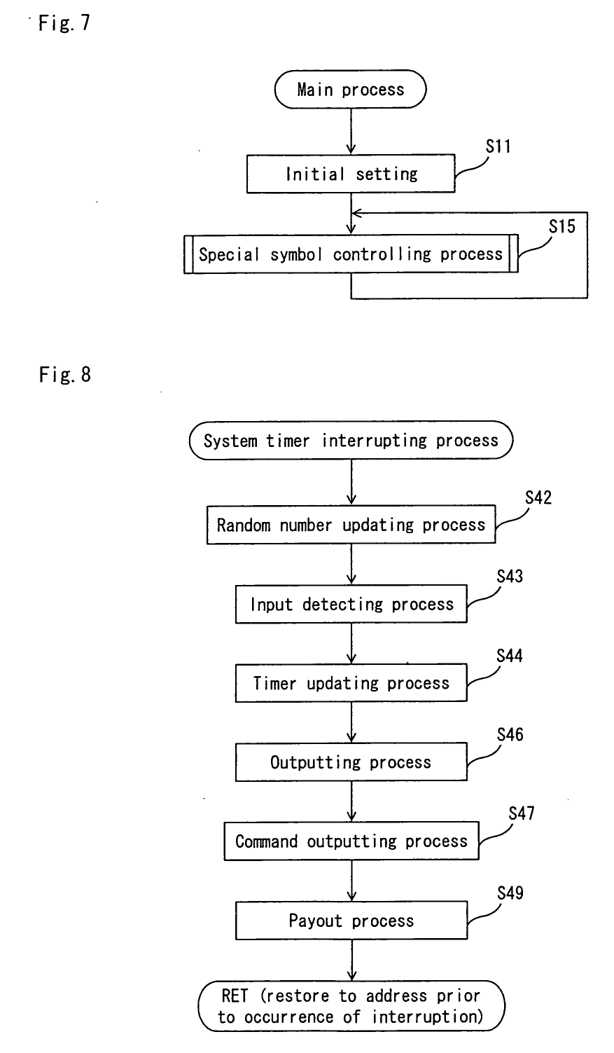

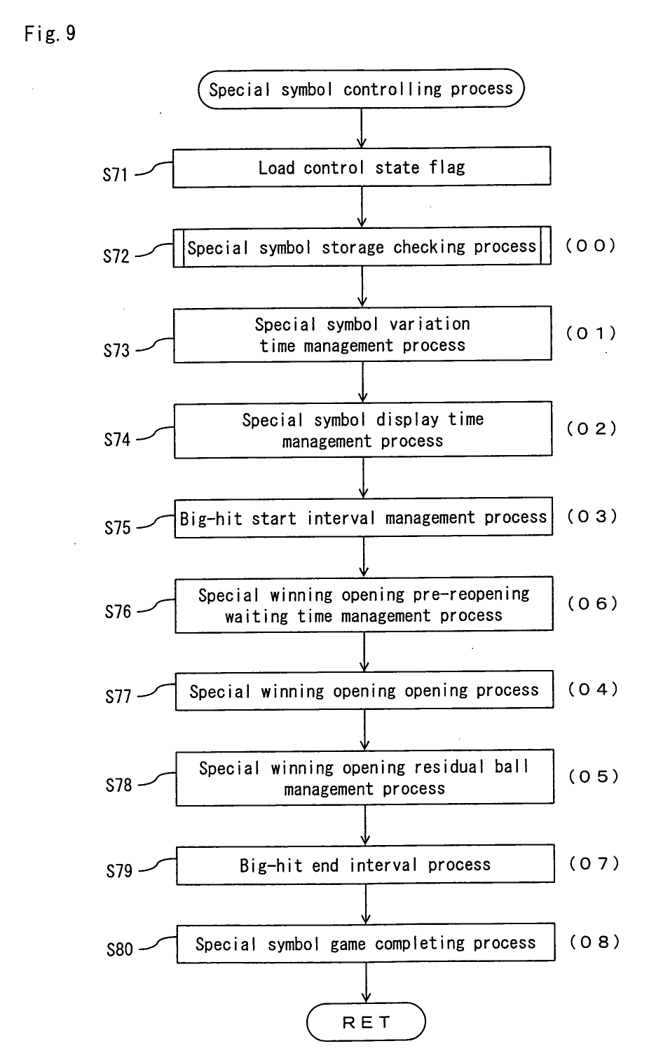

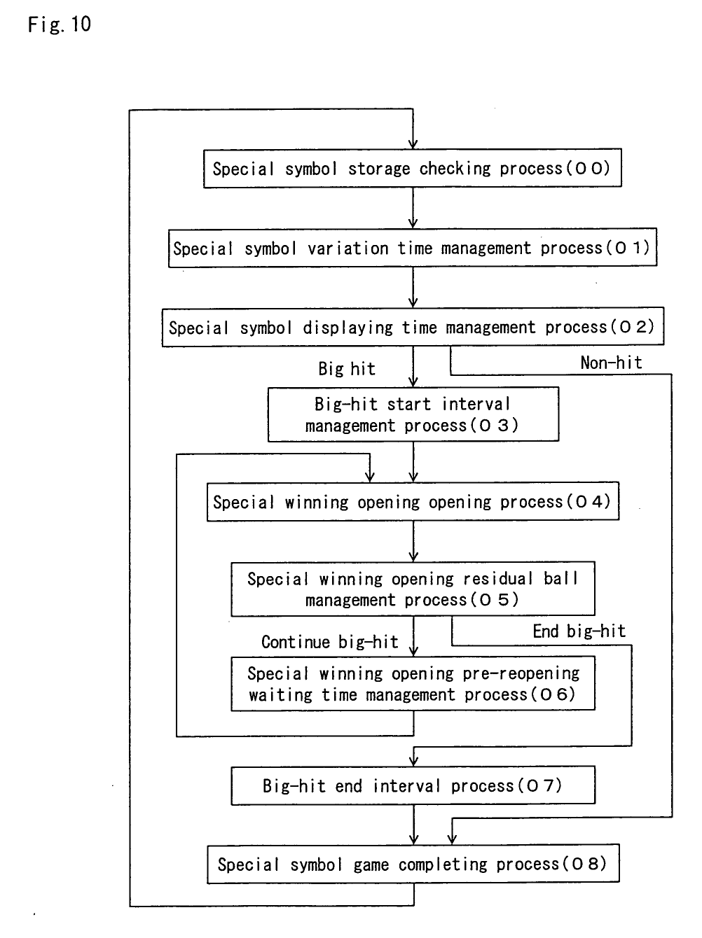

Hereinafter, FIGS. 7 to 9 and FIGS. 11 to 17 illustrate a process which is conducted in the pachinko gaming machine 10. Further, with reference to FIG. 10, there will be described state transitions during special symbol control process (FIG. 9) conducted in the gaming machine 10.

(Main Process)

First, as illustrated in FIG. 7, an initial setting process is conducted (step S11), wherein the initial setting process includes RAM access permission, backup restoration, initialization of work areas and the like. Then, as will be described in detail later with reference to FIG. 9, a special symbol control process relating to the progress of special symbol games, and special symbols and decoration symbols displayed to the liquid crystal display device 32 and on the special symbol display device 33 is conducted (step S15). As described above, in the main process, after the completion of the initial setting process in step S11, the process in step S15 is repeatedly conducted.

(System Timer Interruption Process)

Further, even when the main CPU 66 is executing the main process, the main CPU 66 may interrupt the main process and conduct a system timer interruption process. In response to clock pulses which are generated from the reset clock pulse generation circuit 62 at predetermined intervals (for example, at 2-milisecond intervals), the main CPU 66 conducts the following system timer interruption process. The system timer interruption process will be described with reference to FIG. 8.

First, as illustrated in FIG. 8, the main CPU 66 conducts a random number updating process for incrementing, by one, the respective count values of the big-hit determination random number counter, the big-hit symbol determination random number counter and the like (step S42). In this process, the main CPU 66 conducts an input detecting process for detecting the entry or passage of gaming balls into or through the starting opening 44 and the like (step S43). In this process, the main CPU 66 stores data indicative of the fact that gaming balls should be paid out (awarded), in a predetermined region of the main RAM 70, on the condition that gaming balls have entered various types of winning openings. Then, the main CPU 66 conducts a process for updating various types of timers, such as the waiting time timer for synchronization between the main control circuit 60 and the sub control circuit 200, the special winning opening open time timer for measuring the open time of the special winning opening 39 which opens in the event of occurrences of big-hits (step S44). Then, the main CPU 66 conducts an outputting process for sending signals to solenoids, motors and the like for driving and controlling them, on the basis of various types of variable values (step S46). After the completion of the process, the process is shifted to step S47.

In step S47, a command outputting process is conducted. In this process, the main CPU 66 sends various types of commands to the sub control circuit 200. More specifically, these various types of commands include a demonstration displaying command, a derivative symbol designation command indicative of the type of a special symbol to be derivatively displayed, a variation pattern designation command indicative of a variation display pattern of special symbols, and the like. Namely, the main CPU 66, which conducts this process, sends a variable display result command indicative of the result of variable display of identification information which was determined in step S107 or step S108 and a variable display pattern command indicative of the variable display pattern of identification information which was determined in step S109. Further, in the present embodiment, the main CPU 66 which conducts this process corresponds to exemplary command transmission means. After the completion of the process, the process is shifted to step S49.

Then, in step S49, the main CPU 66 conducts a disbursement process for sending prize ball control commands for causing the disbursement device 128 to pay out prize balls, to the payout/launching control circuit 126. More specifically, the main CPU 66 sends, to the disbursement/shooting control circuit 126, prize ball control commands for paying out a predetermined number of prize balls previously set in the event of entry of a gaming ball into the various types of winning openings. After the completion of the process, this subroutine ends and the main CPU 66 is restored to an address at which it existed prior to the occurrence of the interruption and conducts the main process.

(Special Symbol Controlling Process)

With reference to FIG. 9, the subroutine conducted in step S15 of FIG. 7 will be described. In FIG. 9, the numerical values represented at the sides of steps S72 to S80 indicate the numerical values of the control state flag corresponding to the respective steps and, on the basis of the current numerical value of the control state flag, a single step corresponding to the numerical value is conducted to progress special symbol games.

First, as illustrated in FIG. 9, a process for loading the control state flag is conducted (step S71). In this process, the main CPU 66 reads the control state flag. After the completion of this process, the process proceeds to step S72.

Further, in steps S72 to S80 which will be described later, on the basis of the value of the control state flag, the main CPU 66 determines whether or not various types of processes at the respective steps should be conducted. The control state flag indicates the gaming state of special symbol games and allows one of the processes in steps S72 to S80 to be conducted. In addition thereto, the main CPU 66 conducts the process at the respective steps at predetermined timing based on the waiting time timer, wherein the predetermined timing is set for the respective steps. Further, prior to the predetermined timing, the subroutine ends without conducting the process at the respective steps and another subroutine is conducted. As a matter of course, the system timer interruption process is also conducted at predetermined intervals.

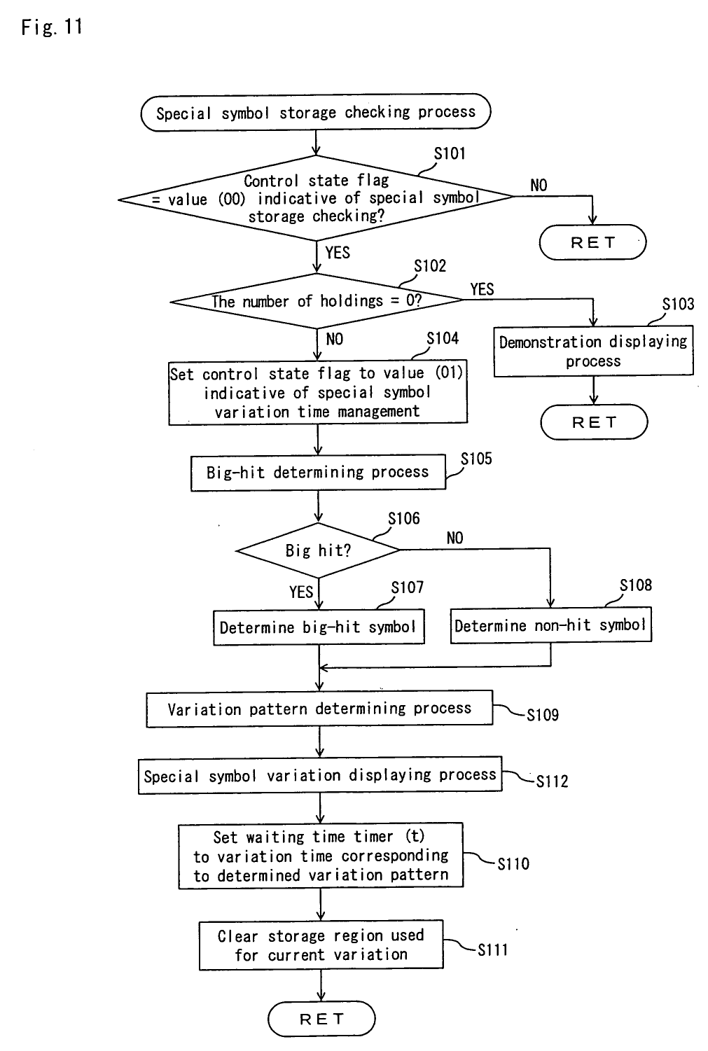

In step S72, a special symbol storage checking process is conducted. As will be described in detail later with reference to FIG. 11, the main CPU 66 checks the number of holdings, when the control state flag has a value (00) indicative of special symbol storage check, and performs big-hit determination, determinations of derivative special symbols, a special symbol variation pattern, and the like, when there is a holding. Further, the main CPU 66 sets the control state flag to a value (01) indicative of special symbol variation time management and also sets the waiting time timer to the variation time corresponding to the variation pattern determined through the current process. Namely, the process in step S73 is set to be conducted after the elapse of the variation time corresponding to the variation pattern determined through the current process. On the other hand, if there is no holding, the main CPU 66 conducts a demonstration displaying process for displaying a demonstration screen. After the completion of the process, the process is shifted to step S73.

In step S73, a special symbol variation time management process is conducted. In this process, the control state flag has a value (01) indicative of special symbol variation time management and, after the elapse of a variation time, the main CPU 66 sets the control state flag to a value (02) indicative of special symbol display time management. Then, the main CPU 66 sets data indicative of a settlement stopping command in a predetermined region of the main RAM 70. The stored data indicative of the settlement stopping command is read, then is converted into command data and then is supplied as a settlement stopping command from the main CPU 66 in the main control circuit 60 to the sub CPU 206 in the sub control circuit 200, through the process in step S47 in FIG. 8. Consequently, the sub control circuit 200 can recognize the timing of derivative displaying of decoration symbols. Then, the main CPU 66 sets the waiting time timer to a post-settlement waiting time (for example, 1 second). Namely, the process in step S74 is set to be conducted after the elapse of the post-settlement waiting time. After the completion of this process, the process is shifted to step S74.

In step S74, a special symbol display time management process is conducted. In this process, the control state flag has the value (02) indicative of special symbol display time management and, after the elapse of the post-settlement waiting time, the main CPU 66 determines whether or not a big-hit occurs. If a big hit occurs, the main CPU 66 sets the control state flag to a value (03) indicative of big-hit starting interval management and also sets the waiting time timer to a time corresponding to a big-hit starting interval (for example, 10 seconds). Namely, the process in step S75 is set to be conducted, after the elapse of the time corresponding to the big-hit starting interval. On the other hand, if a big hit does not occur, the main CPU 66 sets the control state flag to a value (08) indicative of the completion of special symbol games. Namely, the process in step S80 is set to be conducted. After the completion of this process, the subroutine proceeds to the process in step S75. Namely, the main CPU 66, which conducts this process, conducts controls for shifting the gaming state to a big-hit gaming state advantageous to the player, on the condition that variable display of identification information has resulted in a specific display mode. Namely, the main CPU 66 conducts controls for shifting the gaming state to a special big-hit gaming state (a first big-hit gaming state) relatively advantageous to the player or an ordinary big-hit gaming state (a second big-hit gaming state) relatively disadvantageous to the player, on the basis of the type of the big-hit gaming state determined in step S107 which will be described later. In the present embodiment, the main CPU 66 which conducts this process corresponds to exemplary big-hit gaming state shifting control means.

In step S75, a big-hit start interval management process is conducted. In this process, the control state flag has a value (03) indicative of big-hit start interval management and, after the elapse of the time corresponding to the big-hit start interval, the main CPU 66 updates the variable values positioned in the main RAM 70, on the basis of the data read from the main ROM 68, in order to open the special winning opening 39. The main CPU 66 sets the control state flag to a value (04) indicative of opening of the special winning opening and also sets the special winning opening open time timer to an opening upper limit time (for example, 30 seconds). Namely, the process in step S77 is set to be conducted. After the completion of this process, the process is transferred to step S76.

In step S76, a special winning opening pre-reopening waiting time management process is conducted. In this process, if the control state flag has a value (06) indicative of special winning opening pre-reopening waiting time management, after the elapse of the time corresponding to an inter-round interval, the main CPU 66 updates the special winning opening number-of-openings counter by incrementing its count value by one and storing the count value. The main CPU 66 sets the control state flag to a value (04) indicative of opening of the special winning opening. The main CPU 66 sets the special winning opening open time timer to an opening upper limit time (for example, 30 seconds). Namely, the process in step S77 is set to be conducted. After the completion of this process, the process is transferred to as step S77.

In step S77, a process during opening of the special winning opening is conducted. In this process, if the control state flag has a value (04) indicative of opening of the special winning opening, the main CPU 66 determines whether or not any of the condition that the special winning opening entry counter is equal to or greater than “10” and the condition that the opening upper limit time has elapsed (the special winning opening open time timer is “0”) is satisfied (a predetermined closing condition is established). If any of the conditions is satisfied, the main CPU 66 updates the variable values positioned in the main RAM 70, in order to close the special winning opening 39. The main CPU 66 sets the control state flag to a value (05) indicative of special winning opening residual ball monitoring. The main CPU 66 sets the waiting time timer to a special winning opening residual ball monitoring time (for example, 1 second). Namely, the process in step S78 is set to be conducted after the elapse of the special winning opening residual ball monitoring time. If any of the conditions is not satisfied, the main CPU 66 does not conduct the aforementioned process. After the completion of this process, the process is shifted to step S78.

In step S78, a special winning opening residual balls monitoring process is conducted. In this process, if the control state flag has a value (05) indicative of special winning opening residual balls monitoring, after the elapse of a special winning opening residual balls monitoring time, the main CPU 66 determines whether or not the special wining opening open frequency counter is equal to or greater than a maximum number of openings of the special winning opening (the current round is the final round, namely the 15-th round in a special big-hit gaming state or the 2-nd round in a ordinary big-hit gaming state). If the aforementioned condition is satisfied, the main CPU 66 sets the control state flag to a value (07) indicative of a big-hit completion interval and also sets the waiting time timer to the time corresponding to a big-hit completion interval. Namely, the process in step S79 is set to be conducted after the elapse of the time corresponding to the big-hit completion interval. On the other hand, if the aforementioned condition is not satisfied, the main CPU 66 sets the control state flag to a value (06) indicative of special winning opening pre-reopening waiting time management. Further, the main CPU 66 sets the waiting time timer to the time corresponding to the inter-round interval. Namely, the process in step S76 is set to be conducted after the elapse of the time corresponding to the inter-round interval. After the completion of this process, the process is transferred to step S79.

In step S79, a big-hit completion interval process is conducted. In this process, if the control state flag has a value (07) indicative of a big-hit completion interval, after the elapse of the time corresponding to the big-hit completion interval, the main CPU 66 sets the control state flag to a value (08) indicative of the completion of a special symbol game. Namely, the process in step S80 is set to be conducted. Then, the main CPU 66 conducts controls for shifting the gaming state to a probability changing state if big-hit symbols are probability changing symbols and conducts controls for shifting the gaming state to a normal gaming state if the big-hit symbols are non-probability changing symbols. Namely, the main CPU 66, which conducts this process, conducts controls for shifting the gaming state to a probability changing state (an example of a special gaming state) where variable display of identification information can readily result in a specific display mode, after the completion of a big-hit gaming state, on the condition that variable display of identification information has resulted in a special display mode out of specific display modes. In the present embodiment, the main CPU 66 which conducts this process corresponds to exemplary special gaming state shifting control means. After the completion of this process, the process is transferred to step S80.

In step S80, a special symbol game completion process is conducted. In this process, when the control state flag has a value (08) indicative of the completion of special symbol games, the main CPU 66 updates the data indicative of the number of holds (starting storage information) such that it is subtracted by “1”. Further, the main CPU 66 updates the special symbol storage region, in order to perform the next variation display. The main CPU 66 sets the control state flag to a value (00) indicative of special symbol storage checking. Namely, the process in step S72 is set to be conducted. After the completion of this process, this subroutine is completed.

As previously described, by setting the control state flag, special symbol games are executed. More specifically, as illustrated in FIG. 10, when the gaming state is not a big-hit gaming state, if a non-hit is resulted from a big-hit determination, the main CPU 66 sets the control state flag to “00”, “01”, “02” and “08” in the mentioned order to conduct the process in steps S72, S73, S74 and S80 illustrated in FIG. 9 at predetermined timing. Also, when the gaming state is not a big-hit gaming state, if a big-hit is resulted from a big-hit determination, the main CPU 66 sets the control state flag to “00”, “01”, “02” and “03” in the mentioned order to conduct the process in steps S72, S73, S74 and S75 illustrated in FIG. 9 at predetermined timing to perform the control of a big-hit gaming state. Also, when the control of the big-hit gaming state is performed, the main CPU 66 sets the control state flag to “04”, “05” and “06” in the mentioned order to conduct the process in steps S77, S78 and S76 illustrated in FIG. 9 at predetermined timing to perform specific games. Further, when a specific game is being played, if a big-hit gaming state ending condition (a specific game ending condition) is established, the control state flag is set to “04”, “05”, “07” and “08” in this order so that the process in step S77 to step S80 illustrated in FIG. 9 is conducted at predetermined timing and, thus, the big-hit gaming state ends. On the condition that a maximum number of continuous big-hit rounds (an upper limit of the number of rounds, for example, 2 or 15 rounds in the present embodiment) have been completed, as a specific game ending condition, a big-hit gaming state ends.

(Special Symbol Storage Checking Process)

With reference to FIG. 11, there will be described the subroutine which is executed in step S72 in FIG. 9.

First, as illustrated in FIG. 11, it is determined whether or not the control state flag has a value (00) indicative of special symbol storage checking (step S101) and, if the control state flag is determined to have the value indicative of special symbol storage checking, the process is transferred to step S102. If the control state flag is not determined to have the value indicative of special symbol storage checking, this subroutine ends. Then, in step S102, it is determined whether or not the number of holdings is “0”. If it is determined that data indicative of the number of holdings is “0”, the process is transferred to step S103. If it is not determined that the data indicative of the number of holdings is “0”, the process is transferred to step S104.

In step S103, a demonstration displaying process is conducted. In this process, the main CPU 66 stores variable values for sending a demonstration displaying command to the sub control circuit 200 for causing it to perform demonstration displaying. Thus, the sub control circuit 200 can recognize that the gaming state becomes a customer waiting state (predetermined waiting state). After the completion of this process, this subroutine ends.

In step S104, a process for setting the control state flag to the value (01) indicative of special symbol variation time management is conducted. In this process, the main CPU 66 stores the value indicative of special symbol variation time management in the control state flag. After the completion of this process, the subroutine proceeds to the process in step S105.

Then, in step S105, a big-hit determining process is conducted. In this process, the main CPU 66 reads the high probability flag and selects a single big-hit determination table from plural big-hit determination tables having different numbers of values for big-hit determination (big-hit determination values), on the basis of the read high probability flag. For example, a big-hit determination table for use in a normal state includes two big-hit determination values which are set therein while a big-hit determination table for use in a high probability state includes 10 big-hit determination values which are set therein. Since a big-hit determination table is selected on the basis of the high probability flag, the probability that the gaming state is shifted to a big-hit gaming state is varied. Thus, if the high probability flag has a predetermined value (for example, “77”), namely if the gaming state is a probability changing state, the probability that the gaming state is shifted to a big-hit gaming state (the probability that variable display of special symbols results in a specific display mode) is higher than in a normal state. Then, the main CPU 66 refers to a big-hit determination random number value extracted at the time of starting winning and the selected big-hit determination table. Namely, the main CPU 66 determines whether or not the gaming state should be shifted to a big-hit gaming state advantageous to the player. In the present embodiment, the main CPU 66 which conducts the aforementioned process corresponds to exemplary big-hit determination means. After the completion of this process, the process is transferred to step S106.

In step S106, it is determined whether or not a big-hit occurs. In this process, the main CPU 66 determines whether or not a big-hit occurs on the basis of the result of the reference in step S105. If it is determined that a big-hit occurs, the main CPU 66 transfers the process to step S107. If it is not determined that a big-hit occurs, the process is transferred to step S108.

In step S107, the main CPU 66 extracts a big-hit symbol random number value extracted at the time of starting winning, then determines a special symbol on the basis of the big-hit symbol random number value and stores data indicative of the special symbol in a predetermined region of the main RAM 70. Namely, the main CPU 66 which conducts this process determines the result of variable display of identification information, on the basis of the result of determination as to whether or not the gaming state should be shifted to a big-hit gaming state. In the present embodiment, the main CPU 66 which conducts the aforementioned process corresponds to exemplary variable display result determination means. Further, if the main CPU 66 determines a special display mode (a display mode in which the big-hit symbols are probability changing symbols) as the special symbol, it will conduct controls for shifting the gaming state to a probability changing state in step S79. Namely, the main CPU 66 which conducts the aforementioned process determines the gaming state after the end of the big-hit gaming state. In other words, the main CPU 66 determines whether the gaming state should be shifted to a probability changing state where a specific display mode can easily occur or a normal gaming state where a specific display mode can not easily occur, after the end of the big-hit gaming state. The stored data indicative of the special symbol is supplied to the special symbol display device 33. Consequently, the special symbol is derivatively displayed to the special symbol display device 33. Further, the stored data indicative of the special symbol is read, then converted into command data and then is supplied as a derivative symbol designation command from the main CPU 66 in the main control circuit 60 to the sub CPU 206 in the sub control circuit 200, through the process in step S47 in FIG. 8. Thus, the sub control circuit 200 causes the liquid crystal display device 32 to derivatively display decoration symbols associated with the special symbol. After the completion of this process, the process is transferred to as step S109.

On the other hand, in step S108, a non-hit symbol determining process is conducted. In this process, the main CPU 66 determines a special symbol as a non-hit symbol and stores data indicative of the special symbol in a predetermined region of the main RAM 70. Namely, the main CPU 66 which conducts this process determines the result of variable display of identification information, on the basis of the result of determination as to whether or not the gaming state should be shifted to a big-hit gaming state. In the present embodiment, the main CPU 66 which conducts the aforementioned process corresponds to exemplary variable display result determination means. The stored data indicative of the special symbol is supplied to the special symbol display device 33. Thus, the special symbol is derivatively displayed on the special symbol display device 33. Further, the stored data indicative of the special symbol is read, then converted into command data and then is supplied as a derivative symbol designation command from the main CPU 66 in the main control circuit 60 to the sub CPU 206 in the sub control circuit 200, through the process in step S47 in FIG. 8. Accordingly, the sub control circuit 200 causes the liquid crystal display device 32 to derivatively display decoration symbols associated with the special symbol. After the completion of this process, the process is transferred to step S109.

In step S109, a variation pattern determining process is conducted. In this process, the main CPU 66 extracts an effect condition selection random number value. The main CPU 66 selects a variation pattern distribution table for determining a variation pattern, on the basis of the special symbol determined in step S107 or step S108. Then, the main CPU 66 determines the variation pattern on the basis of the effect condition selection random number value extracted from the effect condition selection random number value counter and the selected variation pattern distribution table. Then, the main CPU 66 stores the determined variation pattern in a predetermined region of the main RAM 70. Further, the main CPU 66 determines the variation display mode (particularly, the variation display time) of special symbols, on the basis of data indicative of the variation pattern. Namely, the main CPU 66, which conducts this process, determines the variable display pattern of identification information, on the basis of the result of variable display of identification information determined in step S107 or step S108. In the present embodiment, the main CPU 66 which conducts the aforementioned process corresponds to exemplary variable display pattern determination means.

The stored data indicative of the variation pattern is supplied to the special symbol display device 33. Accordingly, the special symbol is variably displayed on the special symbol display device 33 in the determined variation pattern. Further, the stored data indicative of the variation pattern is read, then converted into command data and then is supplied as a variation pattern designation command from the main CPU 66 in the main control circuit 60 to the sub CPU 206 in the sub control circuit 200, through the process in step S47 in FIG. 8. The sub CPU 206 in the sub control circuit 200 executes display of effects, in accordance with the received variation pattern designation command. Further, such a variation pattern designation command may identify a command for causing a non-hit, a command for causing a special big-hit gaming state and then causing a probability changing state after the completion of the special big-hit gaming state, a command for causing a ordinary big-hit gaming state and then causing a ordinary gaming state after the completion of the ordinary big-hit gaming state, and a command for causing a big-hit gaming state which is a special big-hit gaming state or a ordinary big-hit gaming state. Namely, the main CPU 66 which conducts this process sends, to the sub control circuit 200, a variable display result command indicative of the result of variable display of identification information which was determined in step S107 or step S108 and a variable display pattern command indicative of a variable display pattern of identification information which was determined in step S109. Particularly, the main CPU 66 transmits, to the sub control circuit 200, a variable display pattern command which can identify whether or not variable display of identification information should result in a specific display mode or a special display mode. Then, the main CPU 66 conducts a special symbol variation displaying process by supplying data for starting variation display of special symbols to the special symbol display device 33 (step S112). After the completion of this process, the process is transferred to step S110.

In step S110, a process for setting the waiting time timer to the variation time corresponding to the determined variation pattern is conducted. In this process, the main CPU 66 calculates the variation time, on the basis of the variation pattern determined through the process in step S109 and a variation time table indicative of the variation time of the variation pattern, and then stores a value indicative of the variation time at the waiting time timer. Then, a process for clearing the storage region used for the current variation display is conducted (step S111). After the completion of this process, this subroutine ends.

(Sub Control Circuit Main Process)

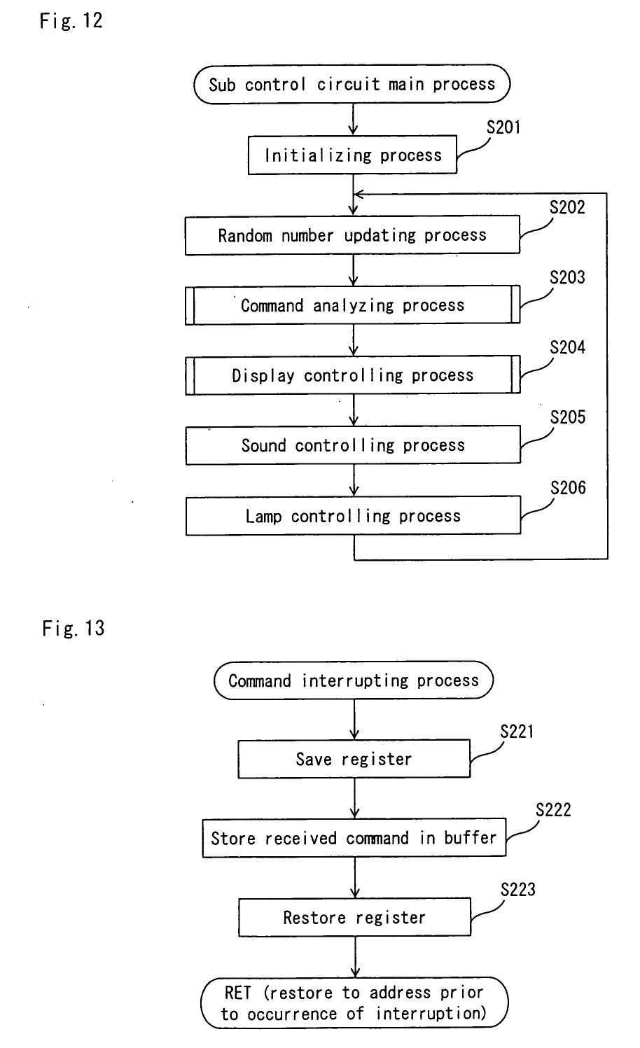

On the other hand, the sub control circuit 200 conducts sub control circuit main processing. The sub control circuit main processing will be described with reference to FIG. 12. Further, the sub control circuit main processing is a process that is started at the time of power up.

First, as illustrated in FIG. 12, the sub CPU 206 conducts an initial setting process such as RAM access permission, initialization of work areas (step S201). After the completion of this process, the process is transferred to step S202.

In step S202, the sub CPU 206 conducts a random number updating process. In this process, the sub CPU 206 updates the random numbers of various types of random number counters which are positioned at predetermined regions of the work RAM 210. After the completion of this process, the process is transferred to step S203.

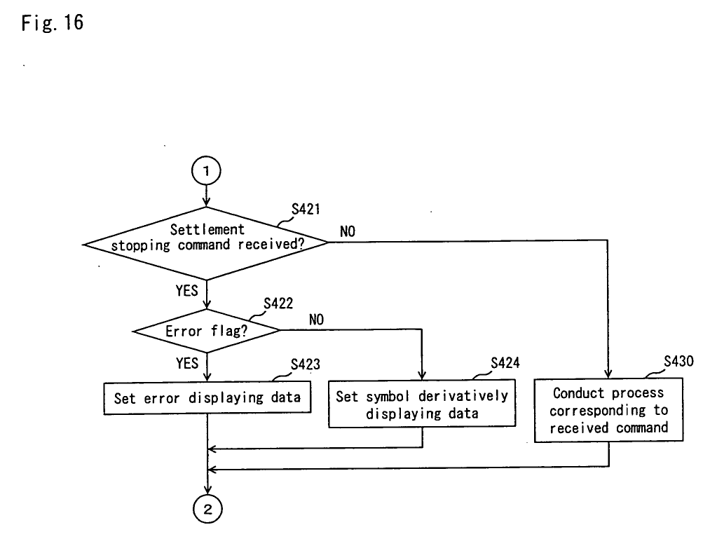

In step S203, the sub CPU 206 conducts a command analyzing process. As will be described in detail later with reference to FIG. 15 and FIG. 16, the sub CPU 206 analyzes received commands and conducts a process in accordance with analyzed commands. After the completion of this process, the process is transferred to step S204.

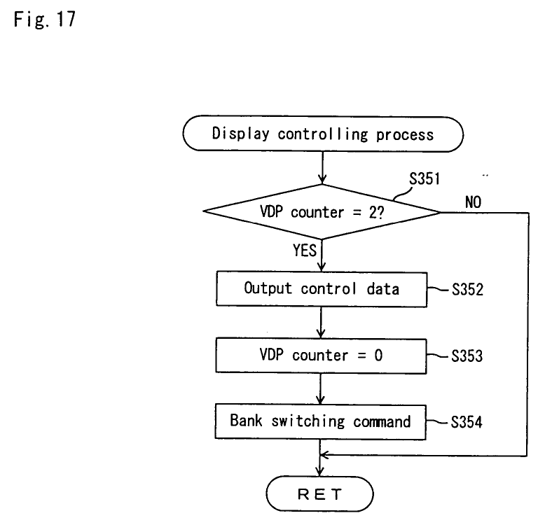

In step S204, the sub CPU 206 conducts a display controlling process. As will be described in detail with reference to FIG. 17, the sub CPU 206 controls the displaying of images on the liquid crystal display device 32.

Then, the sub CPU 206 conducts a sound controlling process for controlling sounds to be generated from the speakers 46 (step S205) and a lamp controlling process for controlling light emission from various types of lamps 132 (step S206). After the completion of this process, the process is transferred to step S202, again.

As described above, in the sub control circuit main processing, after the completion of the initial setting process in step S201, the process in step S202 to step S206 is repeatedly conducted.

(Command Interrupting Process)

Further, the sub control circuit 200 conducts a command interrupting process at predetermined timing (for example, the timing of the reception of a command). The command interrupting process will be described with reference to FIG. 13.

First, as illustrated in FIG. 13, the sub CPU 206 saves a register (step S221) and stores various types of received commands which were received from the main control circuit 60, in a command buffer positioned at a predetermined region of the work RAM 210 (step S222). Then, the sub CPU 206 restores the register which was saved in step S221 (step S223). After the completion of this process, this subroutine ends.

Namely, the sub CPU 206, which conducts the aforementioned process, receives various types of commands (for example, a variation pattern designation command, a derivative symbol designation command) which are transmitted from the main control circuit 60. In the present embodiment, the sub CPU 206 which conducts this process corresponds to exemplary command reception means.

(VDP Interrupting Process)

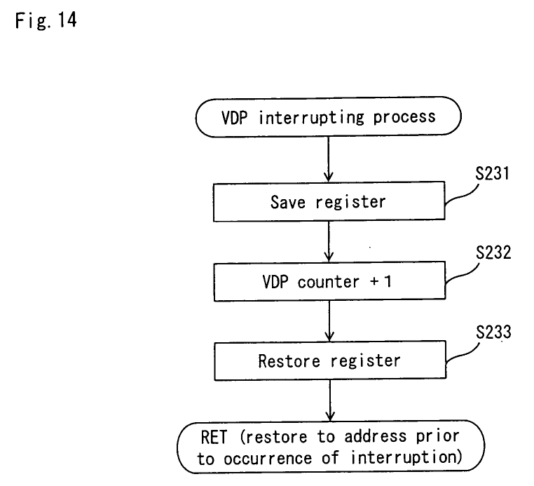

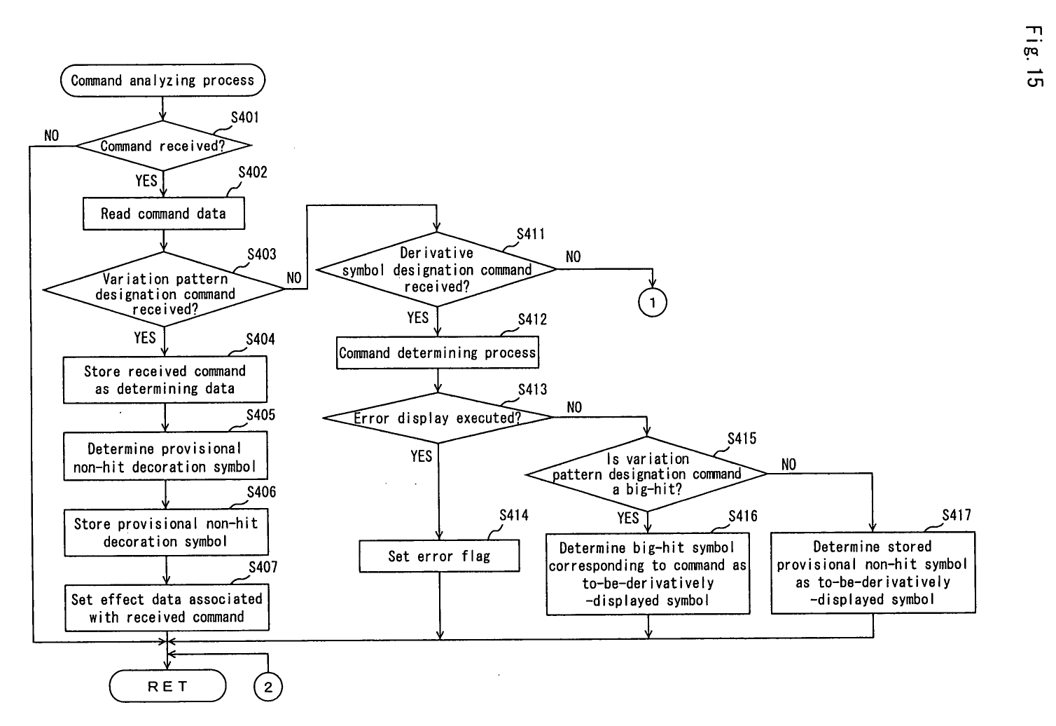

Further, the sub control circuit 200 conducts a VDP interrupting process at predetermined timing (for example, at regular time intervals, such as at the timing of vertical synchronization in the display device ( 1/60s)). The VDP interrupting process will be described with reference to FIG. 14.

First, as illustrated in FIG. 14, the sub CPU 206 saves the register (step S231), then increments, by one, a VDP counter positioned at a predetermined region of the work RAM 210 and stores it (step S232). The VDP counter is a counter used for displaying images and counts the timing of displaying of images. More specifically, every time the present process is conducted, the VDP counter is incremented by one, wherein the present process is called up at every timing of vertical synchronization. Consequently, in a display controlling process which will be described later (see FIG. 17), the sub CPU 206 supplies data for conducting display control to the display control circuit 250, every time the VDP counter is incremented by “2”. Namely, the sub CPU 206 which conducts this process counts the timing of displaying of images. Then, the sub CPU 206 restores the register which was saved in step S231 (step S233). After the completion of this process, the subroutine ends.

(Command Analyzing Process)

With reference to FIG. 15 and FIG. 16, there will be described the subroutine which is executed in step S203 in FIG. 12.

First, as illustrated in FIG. 15, the sub CPU 206 determines whether or not there is a received command (step S401). In this process, the sub CPU 206 determines whether or not there is a received command, on the basis of whether or not there is a command stored in the command buffer in step S222 in the command interrupting process (see FIG. 13). In this process, if the sub CPU 206 determines that there is a received command, it reads command data from the command buffer positioned at a predetermined region of the work RAM 210 (step S402) and then transfers the process to step S403. On the other hand, if the sub CPU 206 determines that there is no received command, it ends this subroutine.

In step S403, the sub CPU 206 determines whether or not it has received a variation pattern designation command. In this process, the sub CPU 206 determines whether or not it has received a variation pattern designation command, on the basis of the command data read in step S402. In this process, if the sub CPU 206 determines that it has received a variation pattern designation command, it transfers the process to step S404. On the other hand, if the sub CPU 206 determines that it has received no variation pattern designation command, it transfers the process to step S411.

In step S404, the sub CPU 206 stores the received command as data for determination. In this process, the sub CPU 206 sets data indicative of the received variation pattern designation command in a predetermined region of the work RAM 210. After the completion of this process, the process is transferred to step S405.

Then, the sub CPU 206 determines provisional non-hit decoration symbols (step S405) and then stores them (step S406) In this process, the sub CPU 206 extracts a random number for determining provisional non-hit decoration symbols, then determines provisional non-hit decoration symbols and sets them in a predetermined region of the work RAM 210. Namely, the sub CPU 206 which conducts the aforementioned process selects one of plural types of results of variable display of identification information in non-specific display modes (different from specific display modes), if it has received a variation pattern designation command (variable display pattern command) which causes variable display of identification information not to result in a specific display mode. Further, in the present embodiment, the sub CPU 206 which conducts the aforementioned process corresponds to exemplary type-of-display-result determination means. Then, the sub CPU 206 sets effect data associated with the received command in a predetermined region of the work RAM 210 (step S407). Since the effect data is set, effects associated with the variation pattern designation command are executed for the time period corresponding thereto. After the completion of this process, this subroutine ends.

In step S411, the sub CPU 206 determines whether or not it has received a derivative symbol designation command. In this process, the sub CPU 206 determines whether or not it has received a derivative symbol designation command, on the basis of the command data read in step S402. In this process, if the sub CPU 206 determines that it has received a derivative symbol designation command, it transfers the process to step S412. On the other hand, if the sub CPU 206 determines that it has received no derivative symbol designation command, it transfers the process to step S421 in FIG. 16.

In step S412, the sub CPU 206 conducts a command determining process. In this process, the sub CPU 206 refers to the command correspondence table (see FIG. 5) and determines the combination of the variation pattern designation command and the derivative symbol designation command. Namely, the sub CPU 206 which conducts this process determines the combination of the variation pattern designation command and the derivative symbol designation command which were received in step S222. In the present embodiment, the sub CPU 206 which conducts this process corresponds to exemplary command determination means. After the completion of this process, the process is transferred to step S413.

In step S413, the sub CPU 206 determines whether or not error displaying should be conducted. In this process, the sub CPU 206 determines whether or not error displaying should be conducted, on the basis of the result of the determination in step S412. Namely, the sub CPU 206 detects a predetermined error, if it determines, as a result of the determination in step S412, that the combination of the variation pattern designation command and the derivative symbol designation command is a combination at the time of an error, on the basis of the data stored in the command correspondence table. More specifically, as indicated by the command correspondence table, the sub CPU 206 determines that error displaying should be conducted in the following states: if it has received a derivative symbol designation command for a ordinary big-hit or a derivative symbol designation command for a non-hit in the case where it has received a variation pattern designation command for a probability changing big-hit; if it has received a derivative symbol designation command for a probability changing big-hit or a derivative symbol designation command for a non-hit in the case where it has received a variation pattern designation command for a ordinary big-hit; or if it has received a derivative symbol designation command for a non-hit in the case where it has received a variation pattern designation command for a big-hit (both a probability changing big-hit and an ordinary big-hit). If the sub CPU 206 determines that error displaying should be conducted, it sets an error flag at a predetermined region of the work RAM 210 (step S414) and then ends this subroutine. Accordingly, in step S423 which will be described later, error displaying data is set and thus a display error image is displayed to the liquid crystal display device 32. On the other hand, if the sub CPU 206 determines that error displaying should not be conducted, it transfers the process to step S415. In the present embodiment, the sub CPU 206 which conducts this process corresponds to exemplary error determination means.

In step S415, the sub CPU 206 determines whether or not the variation pattern designation command is a command for a big-hit. In this process, the sub CPU 206 determines whether or not the variation pattern designation command is a command for a big-hit, on the basis on the received variation pattern designation command. If the sub CPU 206 determines that the variation pattern designation command is a command for a big-hit, it determines big-hit symbols associated with the derivative symbol designation command as decoration symbols to be derivatively displayed, then sets data indicative of the decoration symbols at a predetermined region of the work RAM 210 (step S416) and ends this subroutine. Accordingly, the sub CPU 206 determines big-hit symbols as decoration symbols to be derivatively displayed, in accordance with the received derivative symbol designation command. On the other hand, if the sub CPU 206 determines that the variation pattern designation command is not a command for a big-hit, it determines the provisional non-hit symbols stored in step S406 as decoration symbols to be derivatively displayed, then sets data indicative of the decoration symbols at a predetermined region of the work RAM 210 (step S417) and ends this subroutine. Accordingly, if the sub CPU 206 receives a variation pattern designation command for a non-hit and also receives a derivative symbol designation command for a non-hit, it determines the provisional non-hit symbols set in step S406 as to-be-derivatively-displayed symbols, through normal processing. On the other hand, if the sub CPU 206 receives a variation pattern designation command for a non-hit and also receives a derivative symbol designation command for a big-hit (any of a special big-hit and an ordinary big-hit), it also determines the provisional non-hit symbols set in step S406 as to-be-derivatively-displayed symbols. Namely, if the sub CPU 206 determines that the combination of received commands is a combination of a variation pattern designation command for causing variable display of identification information not to result in a specific display mode and a derivative symbol designation command for causing variable display of identification information to result in a specific display mode, it determines that the result of variable display of identification information determined in step S405, which is not in a specific display mode, should be derivatively displayed.

On the other hand, in step S421 in FIG. 16, the sub CPU 206 determines whether or not it has received a settlement stopping command. In this process, the sub CPU 206 determines whether or not it has received a settlement stopping command, on the basis of the command data read in step S402. In this process, if the sub CPU 206 determines that it has received a settlement stopping command, it transfers the process to step S422. On the other hand, if the sub CPU 206 determines that it has received no settlement stopping command, it sets effect controlling data according to the received command (step S430) and ends this subroutine.

In step S422, the sub CPU 206 determines whether or not there is an error flag. In this process, the sub CPU 206 determines whether or not there is an error flag, on the basis of whether or not an error flag has been set at a predetermined region of the work RAM 210 in step S414. If the sub CPU 206 determines that there is an error flag, it sets error displaying data at a predetermined region of the work RAM 210 (step S423). Accordingly, the sub CPU 206 supplies the error displaying data to the display control circuit 25 at predetermined timing. Then, the display control circuit 250 controls the displaying of an error, on the basis of the error displaying data. Then, the liquid crystal display device 32 displays a display error image, instead of derivatively displaying decoration symbols, as illustrated in FIG. 6(F). Namely, if a predetermined error is determined in step S413, the liquid crystal display device 32 indicates the result of the determination. In the present embodiment, the liquid crystal display device 32 corresponds to exemplary determination result notification means.

On the other hand, if the sub CPU 206 determines in step S424 that there is no error flag, it sets symbol derivatively displaying data at a predetermined region of the work RAM 210. Accordingly, the sub CPU 206 supplies data indicative of the to-be-derivatively-displayed symbols set in step S416 or step S417, to the display control circuit 250, at predetermined timing. Then, the display control circuit 250 controls variable display of decoration symbols, on the basis of the symbol derivatively displaying data. The liquid crystal display device 32 derivatively displays the decoration symbols, instead of displaying a display error image, as illustrated in FIG. 6(D) and FIG. 6(E).

Namely, the sub CPU 206 and the display control circuit 250 cause identification information variably displaying effects, in accordance with the type of the received variation pattern designation command and also cause the result of identification information variable display to be derivatively displayed, in accordance with the received derivative symbol designation command. Particularly, if it is determined at the step S412 and step S413 that the combination of the received commands is a combination of a variation pattern designation command for a non-hit and a derivative symbol designation command for a big-hit, the sub CPU 206 and the display control circuit 250 causes the result of variable display of identification information as a non-hit, which was determined in step S405, to be derivatively displayed. In the present embodiment, the sub CPU 206 and the display control circuit 250 which conduct the aforementioned process correspond to exemplary variable display control means.

As described above, there is stored data capable of identifying the combination of a variable display pattern command and a variable display result command is a combination at the time of an error. Further, the combination of the received variable display pattern command and the variable display result command is determined. As a result, on the basis of the stored data, if the combination of the received variable display pattern command and the variable display result command is determined to be a combination at the time of an error, it is determined as a predetermined error, and the result of the determination is indicated. Accordingly, for example, if a transmitted variable display pattern command and a transmitted variable display result command are accidentally changed due to noises or the like, thus resulting in an abnormal combination of the identification information variably displaying pattern and the result of variable display of identification information, this will be indicated as a predetermined error, which can enhance the reliability of the derivatively displayed identification information without inducing confusion about games, thereby preventing the reduction of enjoyment.

Further, on the condition that variable display of identification information has resulted in a special display mode out of specific display modes, the gaming state is shifted to a special gaming state where variable display of identification information can readily result in a specific display mode, after the end of the big-hit gaming state, and also the variable display pattern command as described above is sent, wherein the variable display pattern command identifies whether or not the variable display of identification information should result in a special display mode. Accordingly, for example, even if the received commands are a variable display pattern command for causing variable display of identification information to result in a special display mode and a variable display result command for causing variable display of identification information to result in a non-special display mode, thus indicating an abnormal combination of the identification information variably displaying pattern and the result of variable display of identification information, this will be indicated as a predetermined error. This can enhance the reliability of the derivatively displayed identification information without inducing confusion about games, thereby preventing the reduction of enjoyment.

Further, if the combination of received commands is determined to be a variable display pattern command for causing variable display of identification information not to result in a specific display mode and a variable display result command for causing variable display of identification information to result in a specific display mode, then a result of variable display of identification information which is not in a specific display mode is derivatively displayed. Accordingly, if the combination of received commands is a variable display pattern command for causing variable display of identification information not to result in a specific display mode and a variable display result command for causing variable display of identification information to result in a specific display mode, this will not be indicated as an error. Even when a result of variable display of identification information which is not in a specific display mode is derivatively displayed, there is a lower possibility that the player can notice the occurrence of an error, which can smoothly progress games and prevent the reduction of the reliability of the derivatively displayed identification information, thereby preventing the reduction of enjoyment.

(Display Controlling Process)

With reference to FIG. 17, there will be described the subroutine which is executed in step S204 in FIG. 12.

First, as illustrated in FIG. 17, the sub CPU 206 determines whether or not the VDP counter is “2” (step S351) In this process, the sub CPU 206 reads the VDP counter value from the VDP counter which is counted in step S232 in the aforementioned VDP interrupting process (see FIG. 14) and determines whether or not it is “2”. Namely, as described above, the VDP counter is incremented by “1” at 1/60-second intervals, in the VDP interrupting process and, therefore, the sub CPU 206 determines whether or not 1/30 second has elapsed. In this process, if the sub CPU 206 determines that the VDP counter is “2”, it transfers the process to step S352. On the other hand, if the sub CPU 206 determines that the VDP counter is not “2”, it ends this subroutine.

In step S352, the sub CPU 206 conducts a control data outputting process. In this process, the sub CPU 206 supplies control data for displaying images to the display control circuit 250. For example, the sub CPU 206 supplies control data indicative of effects, such as data indicative of image data, to the display control circuit 250. Then, the sub CPU 206 sets the VDP counter to “0” (step S353). Then, the sub CPU 206 supplies a bank switching command to the display control circuit 250 (step S354). After the completion of this process, this subroutine ends.

### Other Embodiments

While, in the present embodiment, there is stored data capable of identifying whether the combination of a variation pattern designation command and derivative symbol designation command is a combination at the time of an error, a normal combination or a combination for causing non-hit symbols to be derivatively displayed, the present invention is not limited thereto and, for example, there may be stored data capable of identifying at least whether the combination of a variation pattern designation command and derivative symbol designation command is a combination at the time of an error and it is not necessary that there is stored data for identifying other combinations. Further, while, in the present embodiment, a result of variable display of identification information which is a non-hit is derivatively displayed if a variation pattern designation command for a non-hit and a derivative symbol designation command for a big-hit are received, the present invention is not limited thereto and may perform error displaying, for example.

Further, while, in the present embodiment, a probability changing gaming state is employed as a special gaming state where variable display of identification information can readily result in a specific display mode after the end of a big-hit gaming state, the present invention is not limited thereto and, for example, a time reduction state maybe employed as a special gaming state after the end of a big-hit gaming state, wherein gaming balls can easily enter the starting opening 44 and also the variation time of variable display of identification information is relatively shortened, thereby increasing the probability that the gaming state is shifted to a big-hit gaming state. As a matter of course, it is possible that the special gaming state itself is not employed.

(Configuration of Game Board)

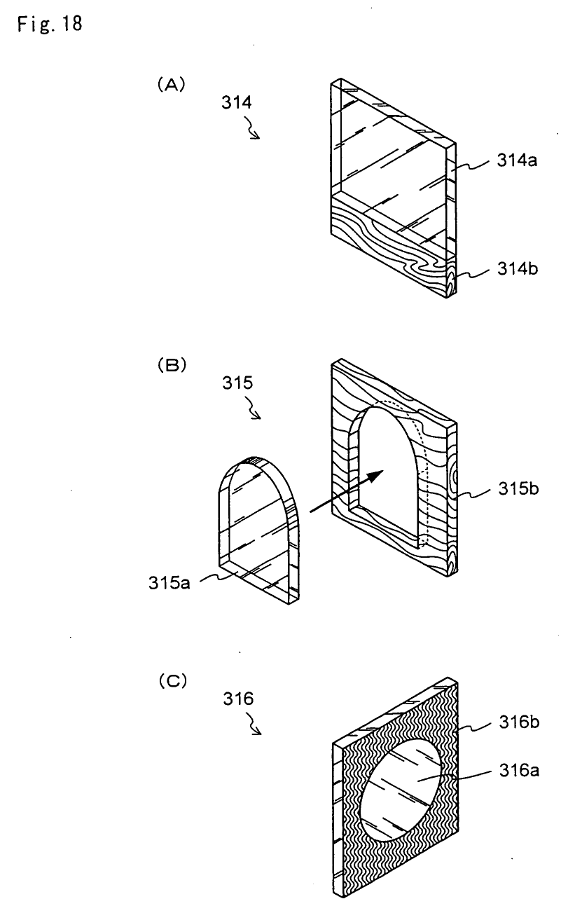

While, in the aforementioned embodiment, the game board 14 is entirely formed from a transparent member, the present invention is not limited thereto and may employ other aspects. An exemplary concrete configuration of the game board will be described with reference to FIG. 18. In FIG. 18, illustration of the plural obstacle nails and the like is omitted, for ease of understanding.

For example, a portion of the game board may be formed from a non-transparent member. More specifically, as illustrated in FIG. 18 (A), a game board 314 may be formed from a combination of a transparent member 314a and anon-transparent plate-shaped member 314b (for example, a wood member). As a matter of course, instead of simply combining the transparent member 314a and the non-transparent member 314b as illustrated in FIG. 18(A), a transparent member 315a may be surrounded by a non-transparent member 315b as illustrated in FIG. 18(B).

Also, for example, the transparent game board may be configured so as to be partially shielded. For example, as illustrated in FIG. 18(C), a portion 316b of a transparent game board 316 may be coated with a color having a light shielding function. In this case, the game board 316 partially has transparency as shown by numerical reference 316a. As a matter of course, instead of applying coating, it is possible to apply blasting processing, light scattering processing for forming a finely coarsened surface with sand paper to cause visible light scattering as if light emission were occurring.

Namely, the game board is required to at least partially have transparency. In other words, it is necessary only that the game board 14 is formed such that images displayed on the display region 32a placed behind the entire portion or a portion of the game region 15 are viewable from the front side through the region around the entire portion or the portion of the game region 15.

Further, while, in the aforementioned embodiment, the game board 14 which entirely or partially has transparency is employed, the present invention is not limited thereto and may employ other aspects and, for example, a non-transparent game board may be employed.

(Configuration of Display Device)

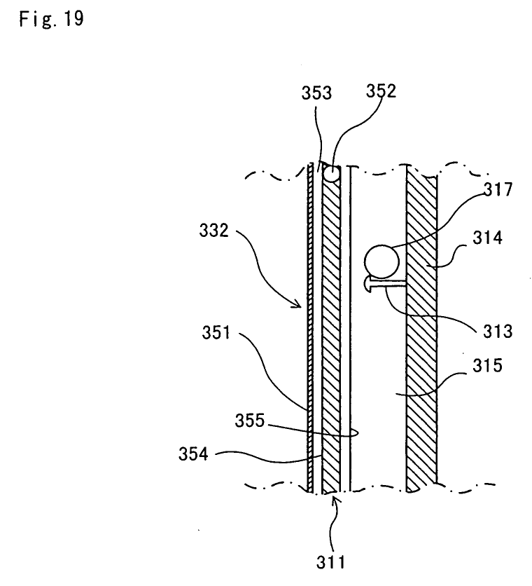

With reference to FIG. 19, there will be described a configuration including a non-transparent game board.

As illustrated in FIG. 19, a display device 332 is provided on a door 311 for displaying various types of effect images. The display device 322 is constituted by a touch panel 351 for detecting coordinate positions being touched by a player, transparent acrylic boards 353 and 355 as protective covers and a liquid crystal display device 354 constituted by a transparent liquid crystal display device between the transparent acrylic boards 353 and 355, which are laminated. The display device 332 (the liquid crystal display device 354) is capable of displaying images having high transparency, on the display region thereof. Further, the liquid crystal display device 354 is also capable of variably displaying special symbols, variably displaying normal symbols and displaying effect images for effects, as well as displaying images having high transparency on the display region.

Further, at an upper portion and a lower portion of the liquid crystal display device 354, there are provided liquid crystal display backlights 352 which serve as illumination devices as back lights of the liquid crystal display device 354. Further, the liquid crystal display backlights 352 are controlled to be lighted at the power-on state. Consequently, the liquid crystal display backlights 352 are kept driven at the power-on state, thereby causing images displayed on the liquid crystal display device 354 to be clearly viewable from the player. As the liquid crystal display back lights 352, cold cathode tubes are mainly employed. However, the present invention is not limited thereto.

Obstacle nails 313 are pounded on the game board 314. A game region 315 is provided between the game board 314 and the door 311 and gaming balls 317 launched onto the game region 315 are allowed to roll thereon.

While the display device 332 includes the touch panel 351, the transparent acrylic boards 353 and 355, the liquid crystal display device 354, the liquid crystal display backlights 352 and the like, the present invention is not limited thereto and may employ other aspects. For example, the display device 322 may include only the liquid crystal display device 354, without including the touch panel 351, the transparent acrylic boards 353 and 355 and the liquid crystal display backlights 352.

As described above, the liquid crystal display device 354 is placed at the front of the game board 314 such that the display region is overlaid on the entire portion or a portion of the game region 315 of the game board 314 and is capable of displaying images having high transparency on the display region. Therefore, images can be displayed in the entire portion or a portion of the game region 315, such that they are viewable from the front side on the liquid crystal display device 354. In other words, the liquid crystal display device 354 is provided at the front of the game board 314 and the game board 314 can be viewed therethrough, and also is a device having a display region for displaying effect images relating to games. Further, the display device may be configured such that it is not overlaid on the game board in the depthwise direction.

While, in the aforementioned embodiment, a first type of pachinko gaming machine has been exemplified, the present invention is not limited thereto and may employ other aspects such as a second type of pachinko gaming machine called a blade type pachinko gaming machine or an aircraft type pachinko gaming machine, a third type of pachinko gaming machine called a right-providing type pachinko gaming machine.

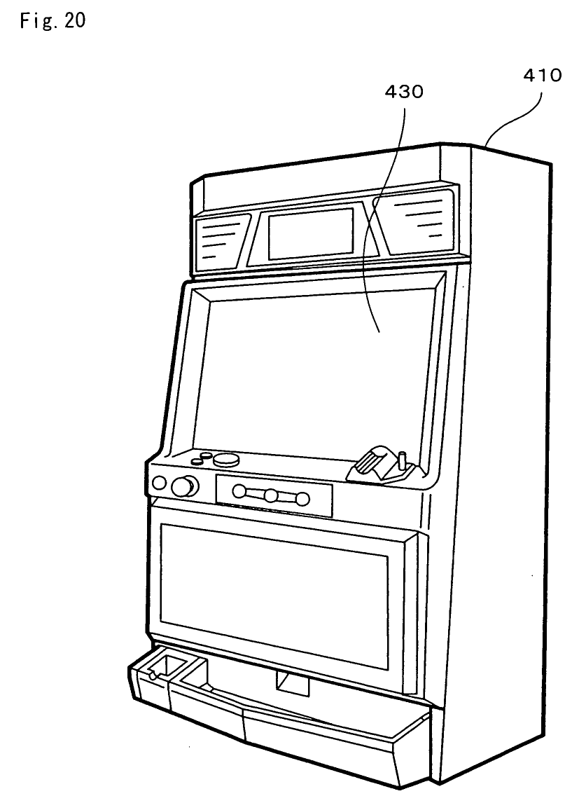

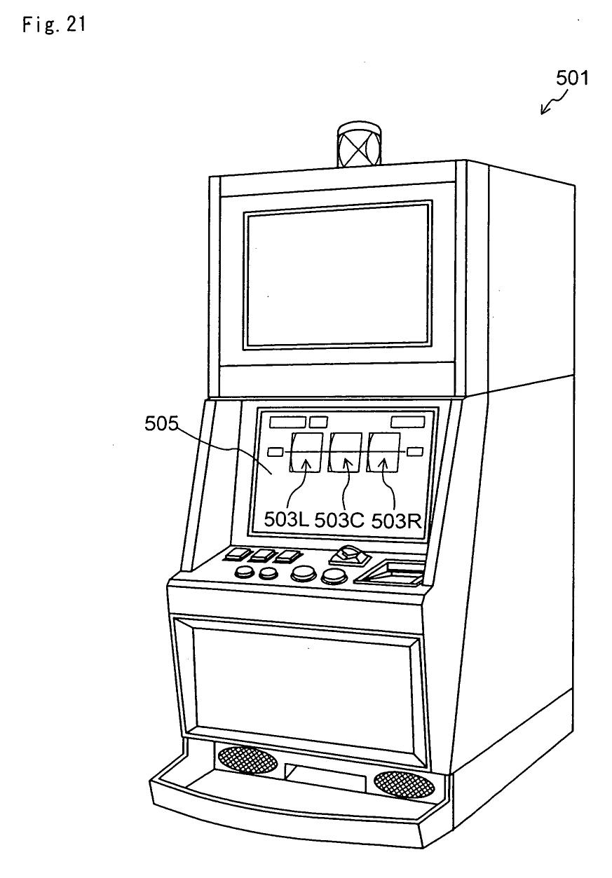

While, in the present embodiment, the present invention is applied to a pachinko gaming machine as illustrated in FIG. 1, the present invention is not limited thereto and may be applied to various types of gaming machines such as a pachi-slot gaming machine 410 as illustrated in FIG. 20, a gaming machine 501 as illustrated in FIG. 21. More specifically, as illustrated in FIG. 20, the pachi-slot gaming machine 410 includes a liquid crystal display device 430 capable of displaying images having high transparency and reels (not shown) provided behind the liquid crystal display device 430. Accordingly, when the liquid crystal display device 430 is displaying images having high transparency, the reels can be viewed by the player. Also, as illustrated in FIG. 21, the gaming machine 501 also includes a liquid crystal display device 505 capable of displaying images having high transparency and reels 503L, 503C and 503R provided behind the liquid crystal display device 505.

While embodiments of the present invention have been described, these embodiments are merely illustrated as concrete examples and are not intended to restrict the present invention. Namely, the present invention is mainly a gaming machine including: variable display means for variably displaying identification information; game control means for controlling games; and effect control means for controlling effects in accordance with the progress of games, the game control means comprising: big-hit gaming state shifting control means for conducting controls for shifting the gaming state to a big-hit gaming state advantageous to a player, on the condition that variable display of the identification information has resulted in a specific display mode; big-hit determination means for determining whether or not the gaming state should be shifted to the big-hit gaming state; variable display result determination means for determining the result of variable display of the identification information, on the basis of the result of determination by the big-hit determination means; variable display pattern determination means for determining the variable display pattern of the identification information, on the basis of the result of variable display of the identification information which was determined by the variable display result determination means; and command transmission means for transmitting a variable display result command indicative of the result of variable display of the identification information determined by the variable display result determination means and a variable display pattern command indicative of the variable display pattern of the identification information determined by the variable display pattern determination means, and the effect control means comprising: command reception means for receiving commands transmitted from the command transmission means; and variable display control means for causing identification information variably displaying effects in accordance with the type of the variable display pattern command received by the command reception means and for causing the result of variable display of identification information to be derivatively displayed, in accordance with the variable display result command received by the command reception means, wherein the command transmission means has the function of transmitting the variable display pattern command, in such a manner that it is capable of identifying whether or not variable display of the identification information should result in a specific display mode, the effect control means comprising: command combination data storage means that stores data capable of identifying whether or not the combination of the variable display pattern command and the variable display result command is a combination at the time of an error; command determination means for determining the combination of the variable display pattern command and the variable display result command which were received by the command reception means; error determination means for detecting a predetermined error, if the command determination means determines that the combination of the variable display pattern command and the variable display result command is a combination at the time of an error, on the basis of the data stored in the command combination data storage means; and determination result notification means for indicating the result of the detection, if the error determination means detects a predetermined error. The concrete configurations of the variable display means, the game control means, the big-hit gaming state shifting control means, the big-hit determination means, the variable display result determination means, the variable display pattern determination means, the command transmission means, the special gaming state shifting control means, the effect control means, the command reception means, the variable display control means, the command combination data storage means, the command determination means, the error determination means, the determination result notification means and the type-of-display-result determination means may be arbitrarily designed and changed.

While most preferable effects of the present invention have been described in the embodiments of the present invention, the effects of the present invention are not limited to those described in the embodiments of the present invention.

What is claimed as new and desired to be secured by Letters Patent of the United States is:

1. A gaming machine comprising:
variable display means for conducting variable display of identification information;
game control means for controlling games; and
effect control means for controlling effects in accordance with the progress of games,
said game control means including:
big-hit gaming state shifting control means for conducting controls for shifting the gaming state to a big-hit gaming state advantageous to a player, on the condition that variable display of said identification information has resulted in a specific display mode;
big-hit determination means for determining whether or not the gaming state should be shifted to said big-hit gaming state;
variable display result determination means for determining a result of variable display of said identification information, on the basis of a result of determination by said big-hit determination means;
variable display pattern determination means for determining the variable display pattern of said identification information, on the basis of the result of variable display of said identification information determined by said variable display result determination means; and
command transmission means for transmitting a variable display result command indicative of the result of variable display of said identification information determined by said variable display result determination means and a variable display pattern command indicative of the variable display pattern of said identification information determined by said variable display pattern determination means, and said effect control means including:
command reception means for receiving commands transmitted from said command transmission means; and
variable display control means for causing conduct of variable display effect of identification information in accordance with the type of the variable display pattern command received by said command reception means, as well as conduct of derivative display of the result of variable display of identification information in accordance with the variable display result command received by said command reception means,
wherein
said command transmission means has the function of transmitting said variable display pattern command such that variable display of said identification information can be identified whether or not to result in a specific display mode, said effect control means including:
command combination data storage means stored with data that is capable of identifying the combination of said variable display pattern command and said variable display result command at the time of an error;
command determination means for determining the combination of the variable display pattern command and the variable display result command each received by said command reception means;
error determination means determining that a predetermined error has been caused, in the case where said command determination means determines that said variable display pattern command and said variable display result command have a combination at the time of an error, on the basis of the data stored in said command combination data storage means; and
determination result notification means for notifying the result of the determination in the case where said error determination means determines that a predetermined error has been caused.

2. The gaming machine according to claim 1,
wherein
said game control means includes special gaming state shifting control means for conducting controls for shifting the gaming state to a special gaming state where variable display of said identification information can readily result in said specific display mode, after the completion of said big-hit gaming state, on the condition that variable display of said identification information has resulted in a special display mode out of said specific display modes, and
said command transmission means has the function of transmitting said variable display pattern command such that variable display of said identification information can be identified whether or not to result in a special display mode.

3. The gaming machine according to claim 1,
wherein
said effect control means includes:
type-of-display-result determination means for determining a result from any of plural types of results of variable display of identification information which are not specific display modes, in the case where said command reception means receives a variable display pattern command in which variable display of said identification information does not result in a specific display mode, and
said variable display control means has the function of causing derivative display of the result of variable display of identification information determined by said type-of-display-result determination means, which is not a specific display mode, in the case where said command determination means determines that the combination of commands received by said command reception means is a combination of a variable display pattern command in which variable display of identification information does not result in a specific display mode and a variable display result command in which variable display of identification information results in a specific display mode.
